(19) United States
(12) Patent Application Publication
(10) Pub. No.: US 2019/0326846 A1
(43) Pub. Date: Oct. 24, 2019

(54) HYBRID UTILITY SYSTEM AND METHOD

(71) Applicant: HCI Eneergy, LLC, Lenexa, KS (US)

(72) Inventors: Reza Ansari, Lake Quivira, KS (US); Kevin M. Dunagan, Kansas City, MO (US); Brian J. Herr, Olathe, KS (US)

(21) Appl. No.: 16/460,360

(22) Filed: Jul. 2, 2019

Related U.S. Application Data
(63) Continuation-in-part of application No. 15/500,788, filed on Jan. 31, 2017, now Pat. No. 10,367,442.

(51) Int. Cl. H02S 10/12; F03D 7/02; F03D 7/06; F03D 9/00; H02S 10/20; H02S 20/32; H02S 50/00; B65D 88/12; C02F 1/00

(52) U.S. Cl. CPC H02S 10/12; F03D 7/02; F03D 7/06; F03D 9/007; H02S 10/20; G01W 1/02; H02S 50/00; B65D 88/121; C02F 1/00; C02F 2201/009; H02S 20/32

(57) ABSTRACT

A transportable, deployable utility system comprising a housing including a frame and mounting a subframe. Solar panels, wind turbine(s), fuel cells, fuel reformers, and other energy sources can be placed in and mounted on the housing. A photovoltaic solar panel array is mounted on the housing for movement between a retracted, storage position and an extended, use position. The housing frame and subframe include tubular members which can be releasably interconnected by clamping connectors.

### CROSS-REFERENCE TO RELATED APPLICATIONS

This application is a continuation-in-part of and claims priority in U.S. patent application Ser. No. 15/500,788, filed Jan. 31, 2017, which claims priority in International Application No. PCT/US2016/057179, filed Oct. 14, 2016, and is also a continuation-in-part of and claims priority in U.S. patent application Ser. No. 14/883,335, filed Oct. 14, 2015, now U.S. Pat. No. 9,780,720, which is a continuation-in-part of and claims priority in U.S. patent application Ser. No. 13/769,113, filed Feb. 15, 2013, now U.S. Pat. No. 9,221,136, which claims priority in U.S. Provisional Patent Application No. 61/600,094, filed Feb. 17, 2012, all of which are incorporated herein by reference.

### BACKGROUND OF THE INVENTION

### 1. Field of the Invention

The present invention relates generally to hybrid utility systems and methods, and in particular to a transportable, hybrid utility system which can operate in multiple utility modes and which can be configured for installation in various sizes and configurations of housings, including standard ISO shipping containers and in cabinets.

### 2. Description of the Related Art

Utility services, such as electrical power, fuel, water, wastewater and other utilities, are required for various activities and for operating a wide variety of powered devices. Conventional utility services are often unavailable at remote locations and are susceptible to service interruptions. For example, natural disasters often interrupt electrical power services by disabling power generation, transmission and delivery infrastructure. Fuel, water, wastewater, telecommunications and other essential resources are similarly susceptible to interruption. Other applications for hybrid utility systems include construction projects at remote locations, disaster recovery efforts and military operations.

Such hybrid utility systems are preferably self-contained and capable of providing output without resource input. For example, solar and wind energy sources can be effectively deployed in various hybrid utility applications.

Transportability is another objective of hybrid utility systems, particularly those designed for deployment in remote locations. Various transportation modes, such as over-the-road trucking, railroads, marine and air, can accommodate standardized ISO shipping containers. Such containers can be equipped with multiple, independent utility components for generating electricity, handling telecommunications, processing wastewater and other functions. Moreover, they are relatively easy to handle and transport with standardized logistics equipment. Deployment in geographically remote areas can thus be achieved efficiently and cost-effectively. Still further, after deployments the hybrid utility systems in shipping containers can be removed and repurposed at other sites. Alternatively, hybrid utility systems can be configured for permanent installations supporting a variety of functions, including transportation and communication operations.

Heretofore there has not been available a deployable hybrid power box with the advantages and features of the present invention.

### SUMMARY OF THE INVENTION

The present invention relates to a transportable, deployable system comprising a hybrid power box containing solar panels, wind turbine(s), fuel cells, fuel reformers, and other energy sources. The system could also include waste water and potable water inlet and outlet ports for water treatment. It will also allow for shelf-mounted solar and wind turbine installation for disaster recovery, backup power for telecommunication, military power, Homeland Security power, off grid homes and water and wastewater packaging domestically and internationally.

In use, the invention is placed at a remote location, at the site of an emergency, or may alternatively be used as a backup power source for an otherwise powered location.

The power box may contain a variety of energy-producing means in a variety of combinations. An exemplary embodiment, for example, will include a wind turbine, a solar panel array, and a number of fuel cells or fuel reformers. The box can be placed at a localized site where power is needed, and the various energy-creating devices can be deployed. The box may contain a number of rechargeable batteries for storing power generated in excess of power being consumed.

A hybrid power box may also contain a system for the treatment of waste water or potable drinking water. It can also contain a water storage tank and components for purifying water. The box can hold and/or process wastewater internally, and can output treated water for environmentally-acceptable disposal or recycling.

The box or housing for the hybrid utility system can be configured for externally mounting equipment, such as wind generators and telecommunications antennae. Still further, multiple housings can be coupled together for increased utility output. The present invention includes a novel connector configured for clamping frame components together, thus accommodating external equipment frames and multi-housing systems. The clamping connector is configured for efficient installation and removal, thus expediting such operations.

### BRIEF DESCRIPTION OF THE DRAWINGS

The drawings constitute a part of this specification and include exemplary embodiments of the present invention illustrating various objects and features thereof.

FIG. 1 is an isometric view of an embodiment of the present invention.

FIG. 2 is an isometric view of the same, as viewed from the opposite corner.

FIG. 3 is an isometric view of an embodiment of the present invention displaying the internal components through a cut-away.

FIG. 4 is an isometric view of an embodiment of the present invention demonstrating the internal components being deployed.

FIG. 5A is an isometric view of an embodiment of the present invention demonstrating a wind turbine being ejected from the main body.

FIG. 5B is an isometric view of the same, showing the wind turbine being rotated and lifted into a final position.

FIG. 6 is an isometric view of an alternative embodiment of the present invention.

FIG. 7 is another isometric view thereof, showing a cutaway view inside of the alternative embodiment.

FIG. 8 is another isometric view thereof, showing an array of solar panels extending from the container.

FIG. 9 is another isometric view thereof, showing the array of solar panels fully extended and opened.

FIG. 10 is a side elevational view thereof, including a diagrammatic representation of components located within the container.

FIG. 11 is a flowchart diagramming the steps taken in practicing an embodiment of the present invention.

FIG. 12 is a three-dimensional isometric view of an alternative embodiment of the present invention disclosing additional features including a scissor-type mover.

FIG. 13 is a side elevational view of the scissor-type mover element thereof.

FIG. 14 is a top plan view thereof.

FIG. 15 is a front elevational view thereof.

FIG. 16 is a three-dimensional isometric view of the alternative embodiment thereof, showing additional features.

FIG. 17 is a side elevational view thereof diagrammatically showing additional features.

FIG. 18 is a three-dimensional isometric view of another alternative embodiment thereof, showing additional features in a deployed, operational configuration including a raised wind turbine mast.

FIG. 19 is a front elevational view thereof.

FIG. 20 is a left side elevational view thereof.

FIG. 21 is a three-dimensional isometric view thereof, showing the wind turbine mast in a lowered, transport position.

FIG. 22 is a front, elevational view thereof.

FIG. 23 is an end, elevational view thereof, showing a solar panel array in hidden lines and partially extended from a top hat housing subassembly.

FIG. 24 is a three-dimensional isometric view thereof, showing the wind turbine mast in a lowered, transport position.

FIG. 25 is an enlarged, isometric view of a base mounting subassembly for the wind mast.

FIG. 26 is another enlarged, isometric view of the base mounting subassembly.

FIG. 27 is a fragmentary, isometric view of a mounting bracket for the base mounting subassembly.

FIG. 28 is a three-dimensional, isometric view of a hybrid utility system comprising another alternative embodiment of the present invention.

FIG. 29 is a front elevational view thereof.

FIG. 30 is an end elevational view thereof.

FIG. 31 is a three-dimensional, isometric view of a hybrid utility system including a cabinet housing and comprising another modified or alternative embodiment of the present invention.

FIG. 32 is a front elevational view thereof.

FIG. 33 is an end elevational view thereof.

FIG. 34 is another three-dimensional, isometric view thereof.

FIG. 35 is a three-dimensional, isometric, exploded view of the frame components at an upper corner of the hybrid utility system, shown with a clamping connector and embodying another alternative aspect of the present invention.

FIG. 36 is another isometric view thereof.

FIG. 37 is an isometric view of the structural frame components at a lower corner and positioned for attachment by the clamping connector.

FIG. 38 is another isometric view thereof.

FIG. 39 is an isometric view at a top corner with the clamping connector partially assembled.

FIG. 40 is another isometric view thereof.

FIG. 41 is an isometric view at a bottom corner with the clamping connector partially assembled.

FIG. 42 is another isometric view thereof.

FIG. 43 is an isometric view with the clamping connector exploded and oriented for a top corner.

FIG. 44 is another isometric, exploded view thereof.

FIG. 45 is an isometric view with the clamping connector exploded and oriented for a bottom corner.

FIG. 46 is another isometric, exploded view thereof.

FIG. 47 is a fragmentary, cross-sectional of a top corner connection, with the main frame and a subframe separated and aligned for attachment by the clamping connector.

FIG. 48 is another cross-sectional view of the top corner connection, showing the main frame mounting the subframe with the clamping connector engaged.

### DETAILED DESCRIPTION OF THE PREFERRED EMBODIMENTS

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The present invention solves issues with the remote commissioning of power generation by completing and testing the complete renewable energy system in a single transportable package. That package can be shipped to a job site or remote location for immediate power production and/or water treatment.

The present invention features a transportable power box system 2 comprising generally a transport container 4 containing a plurality of power generation elements and water treatment elements for use in specific situations and locations, including emergency response situations, isolated off-grid locations, construction sites, military zones, and third-world countries. A preferred embodiment occupies a standard ISO shipping container with dimensions of 8 feet by 10 feet by 20 feet, or 8 feet by 10 feet by 40 feet. Sizes may vary though, depending on what components are necessary for a particular box. Ideally, renewable energy sources such as solar and wind power are used; however, gas-powered generators or other power sources can be included for additional power production.

### II. Preferred Embodiment or Aspect Transportable Hybrid Power System 2

The embodiments discussed herein are merely illustrative of specific manners in which to make and use the invention and are not to be interpreted as limiting the scope of the instant invention.

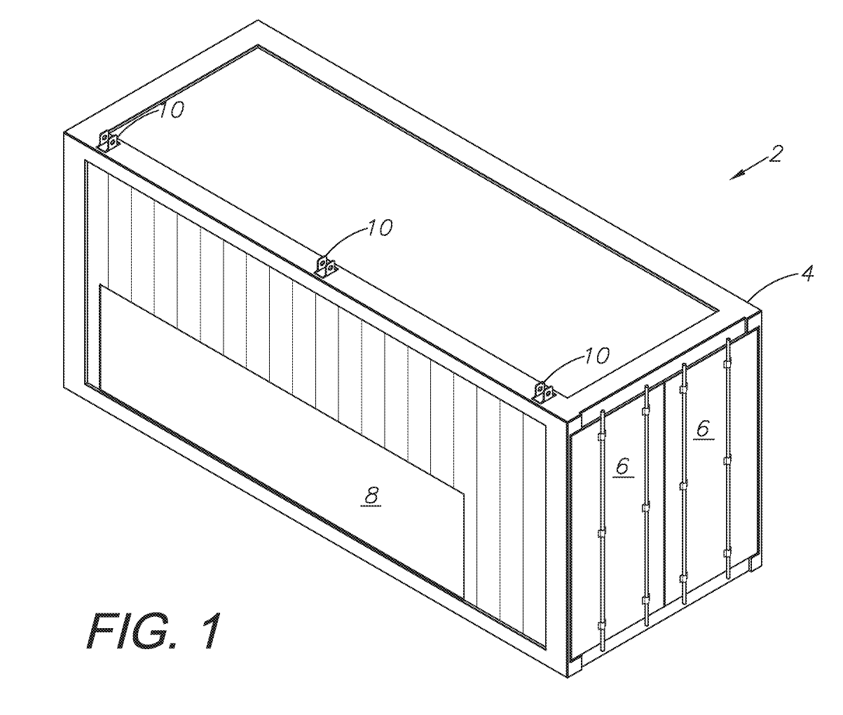

Referring to the drawings in detail, FIG. 1 illustrates a perspective view of a hybrid power system 2 taken from one corner. The system primarily includes a transport container box 4, typically an ISO shipping container. A pair of doors 6 are hingedly mounted to one side of the box 4. These doors could alternatively be a rolling vertical door, or any other type of common opening. These doors provide access to the internal components stored within the box 4.

A wind turbine access window 8 is shown in a close position. This window panel is cut into a side of the box 4, and allows the wind turbine power generation sub-system 26 to be ejected from within the box 4.

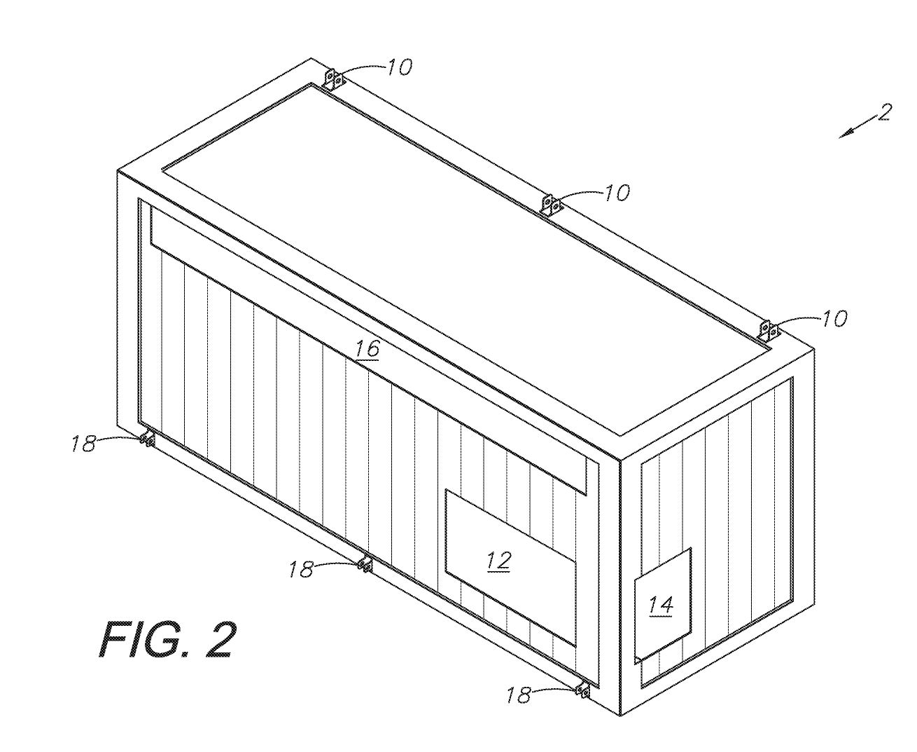

As shown more clearly in FIG. 2, a number of roof brackets 10 and side brackets 18 may be mounted to the exterior of the box 4 for use in anchoring the solar panel array 20 for optimal alignment.

FIG. 2, shown from the opposite corner as FIG. 1, shows a side window 12 and rear window 14 which allow access to power generation elements within the box 4, including a fuel cell power sub-system 42. Another window 16 allows the solar panel array 20 to extend out from within the confines of the box 4.

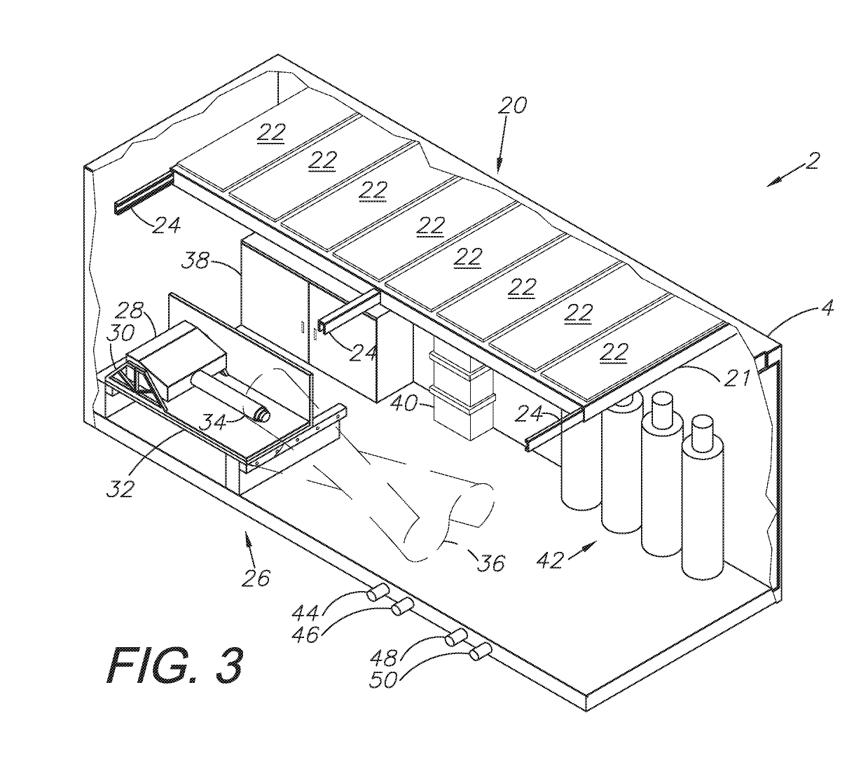

FIG. 3 provides a view to the interior of the box 4, including a variety of power generating elements and other elements for use with the transportable power system 2. The embodiment displayed in FIG. 3 includes a wind turbine power sub-system 26, a solar panel array 20, a fuel cell power sub-system 42, a storage closet 38, and a number of batteries 40 for storing power generated by the various power generating sub-systems.

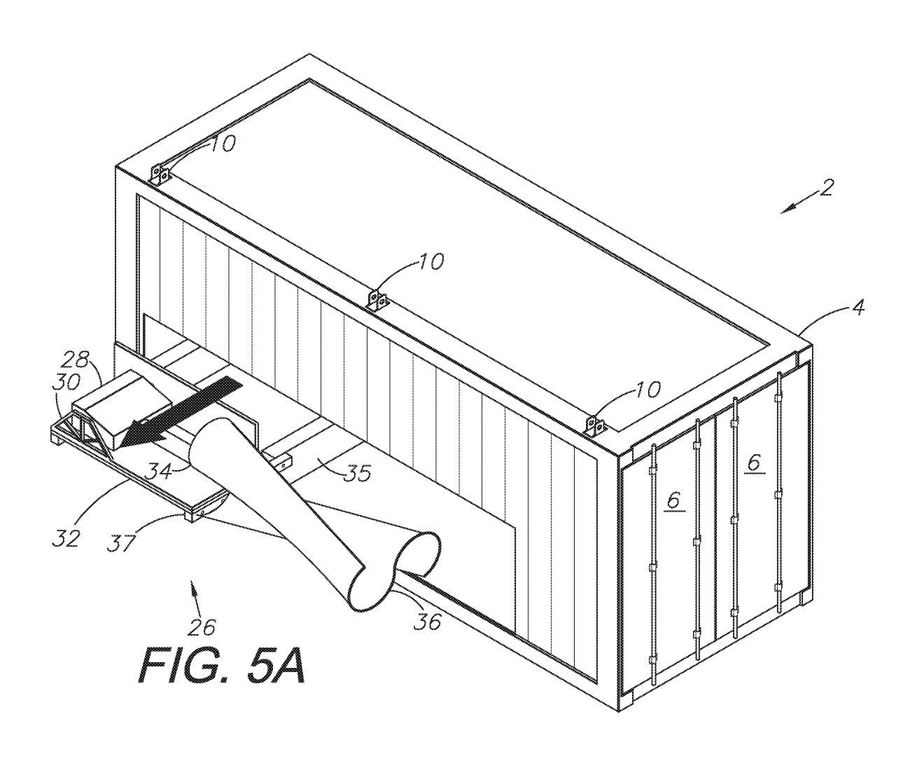

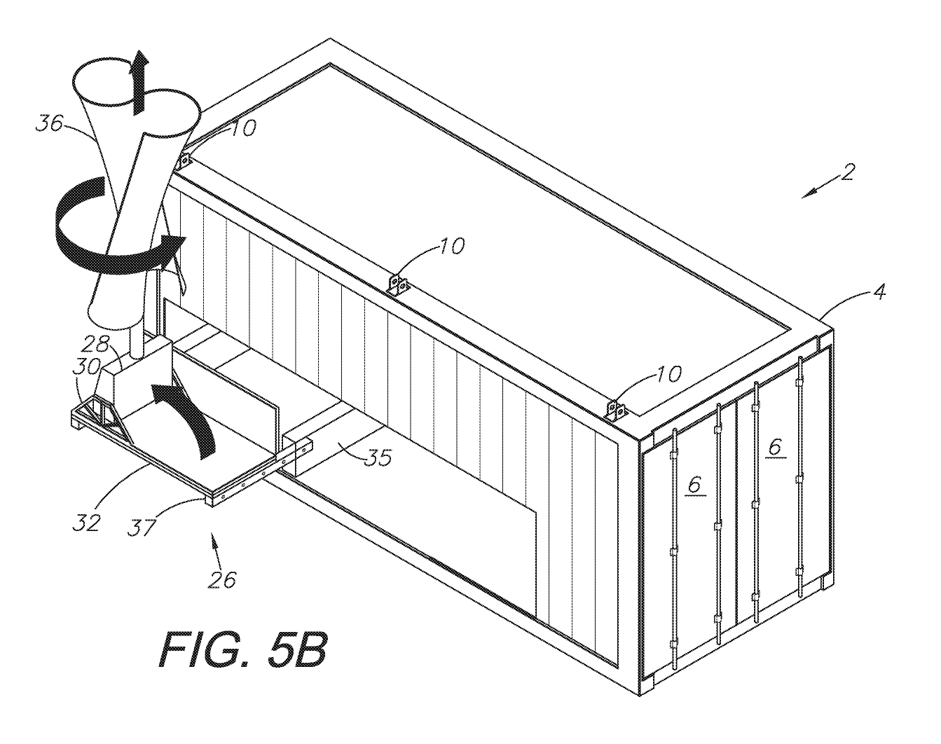

An exemplary wind turbine sub-system includes a turbine base 28 hingedly mounted to a slide base 32 via a pair of mounting rails 30. A hydraulic extension arm 34 is affixed to the turbine base to raise and lower the wind turbine sail 36. As shown in more detail in FIGS. 5A and 5B, the wind turbine power sub-system 26 slides through the space left by window panel 8 when that panel is opened or removed. The wind sub-system slides out from the box 4 on a pair of rails 37 which are connected to a rail base 35 attached to the floor of the box. Once the wind sub-system slides out, as shown in FIG. 5A, the turbine base 28 can be rotated 90 degrees, as shown in FIG. 5B, and the wind sail 36 can be raised into the air to generate clean electricity from the wind.

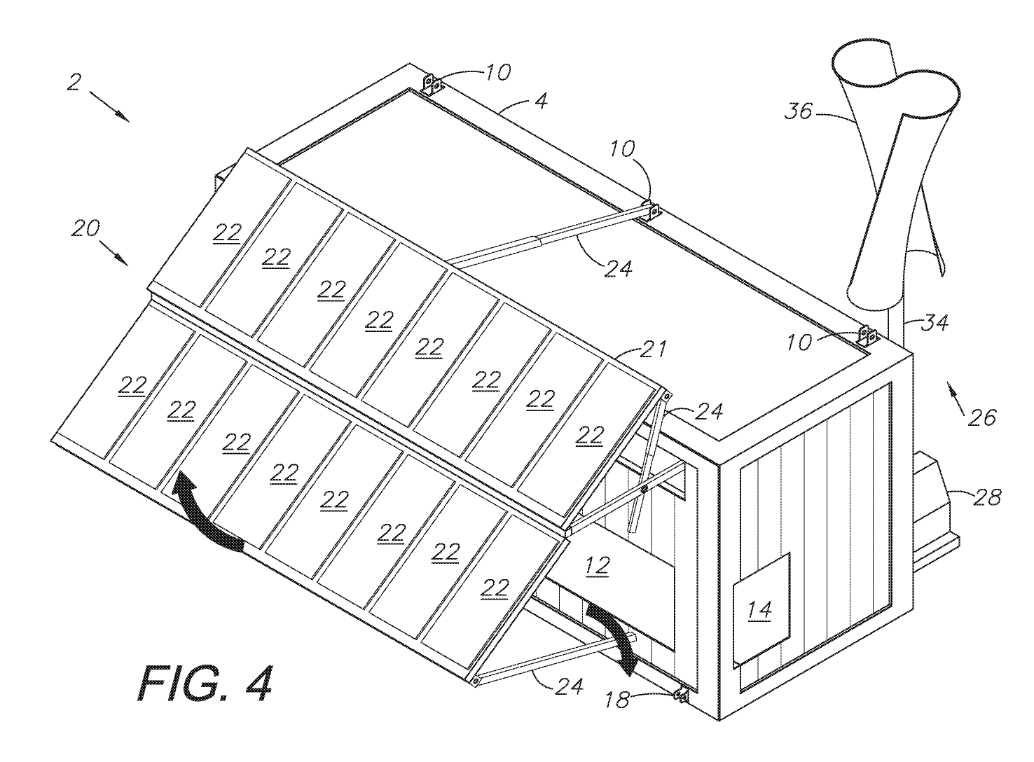

As shown in FIG. 4, an exemplary solar panel array 20 includes a plurality of solar panels 22 mounted onto a solar panel frame 21. An embodiment of such an array may include multiple sets of panels which are folded on top of one another when stored, as shown in FIG. 3, but which are hingedly connected and may be extended for additional solar collection as shown in FIG. 4. In an embodiment of the present invention, the solar array 20 includes a number of frame members 24 which connect to roof brackets 10 and side brackets 18 for securing the array when it is in use.

An embodiment of the present invention may also include a water treatment sub-system. As shown in FIG. 3, potable water inlet 44 and outlet 46 ports would allow for water to be added to a storage tank (not shown) within the box 4, or into a water treatment device (not shown) where the water is treated and then stored. The water may then be used as drinking water.

Similarly, a wastewater inlet 48 and outlet 50 port could allow for the storage and draining and/or treatment of waste water. This could be especially effective in an emergency situation where waste water is a health concern.

Because the entire system is contained within a standard shipping container, the system can be delivered to a remote location via transport truck, railcar, or shipping barge. Smaller systems stored in smaller boxes can be delivered in the backs of standard commercial pick-up trucks or on trailers.

### Alternative Embodiment or Aspect Transportable Hybrid Power System 102

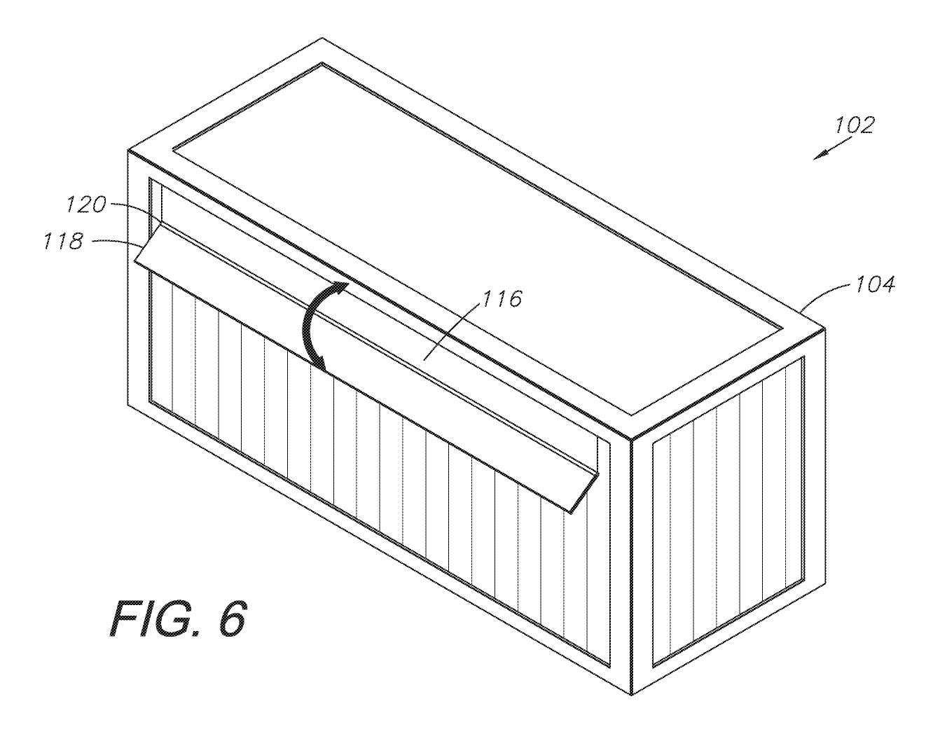

FIGS. 6-10 show an alternative embodiment of a transportable hybrid power system 102. FIG. 6 shows a container unit 104 including a panel 118 connected to the container via a hinge 120 or other suitable connection element which allows the panel 118 to move, exposing an opening 116 for the solar panel array 115.

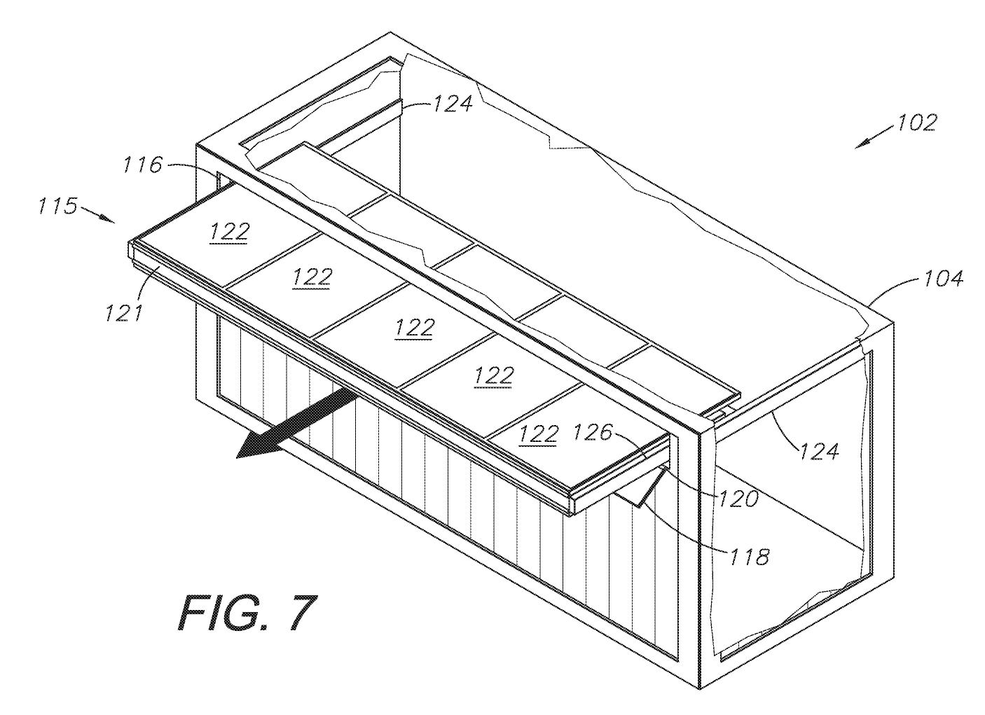

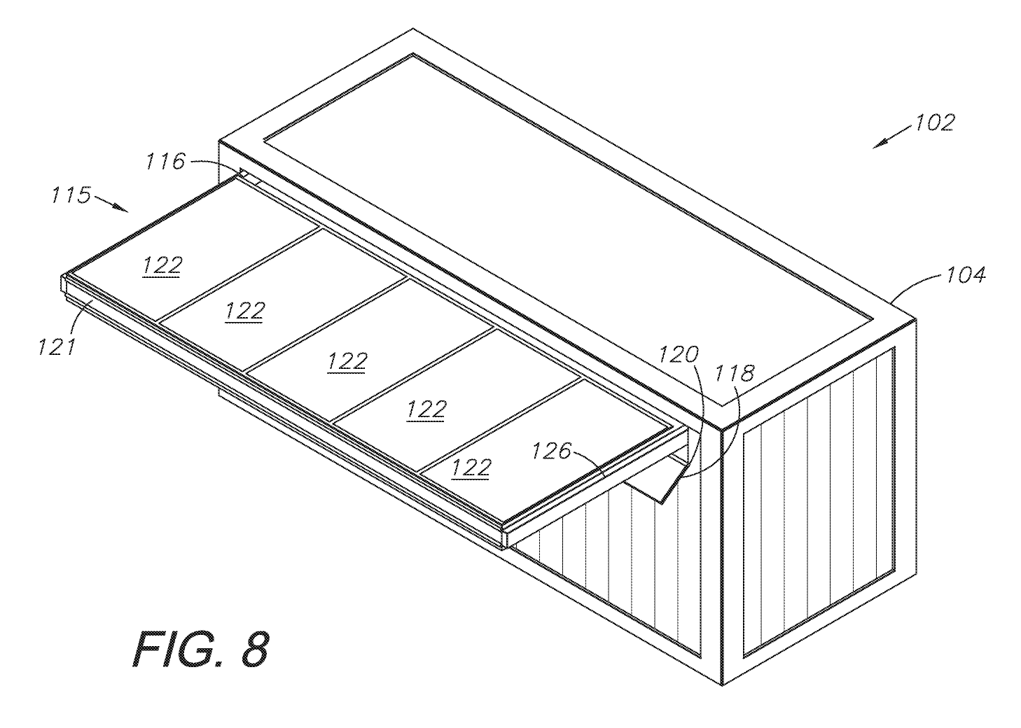

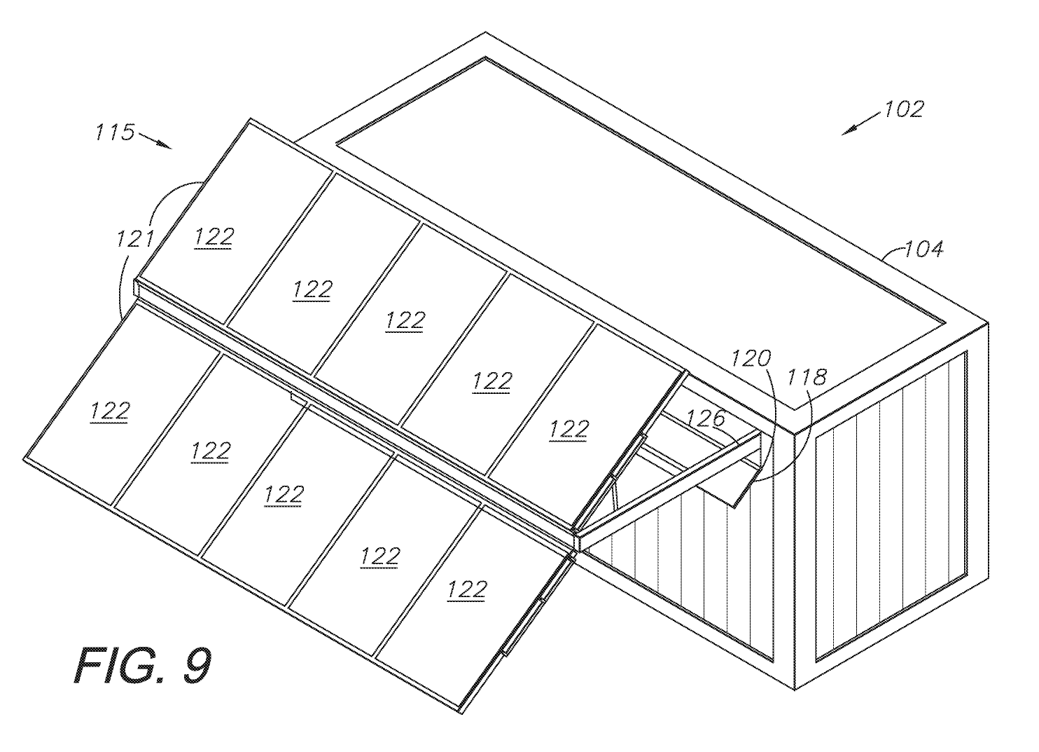

FIG. 7 shows a cut-away view of some of the internal construction of the container 104. A pair of tracks 124 are mounted to either end of the container 104. Corresponding rails 126 are affixed to either end of the solar panel array 115, the rails 126 mounting the array 115 to the tracks 124 and allowing the entire array to slide in and out of the opening 116 in the container 104 exposed by the panel 118. In a preferred embodiment, the array 115 includes several solar panels 122 mounted to a frame 121 or built directly into a frame. The array 115 includes an upper set of panels 122 and lower set of panels 122 as shown more clearly in FIGS. 8 and 9. FIG. 8 shows the array 115 completely extended from within the container 104. The array 115 may be moved along the tracks 124 by using a hydraulic arm, pulleys, or any other suitable mechanical or electrical means of guiding the array out of the opening 116 of the container.

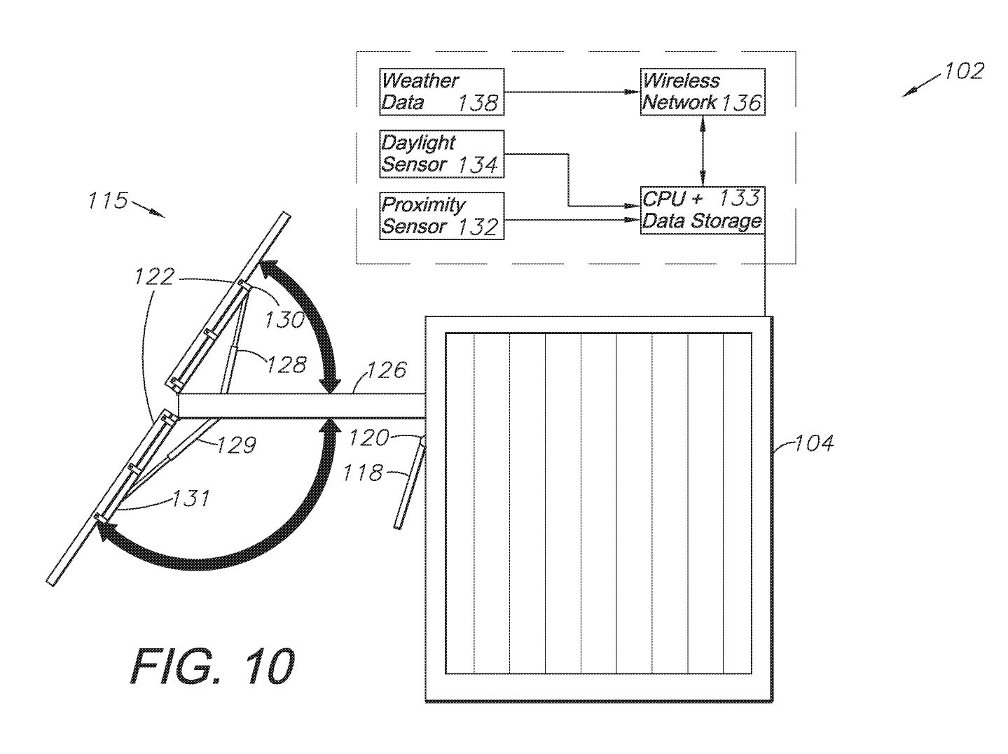

FIG. 9 shows the array 115 as the upper and lower sets of panels are pushed out to an optimal angle to receive solar light for providing electrical power. As shown in FIG. 10, an upper hydraulic arm 128 connected to an upper frame 130 pushes the upper set of panels upward, while a lower hydraulic arm 129 connected to a lower frame 131 pushes the lower set of panels downwards and outwards away from the starting position shown in FIG. 8.

FIG. 10 further shows a variety of instruments included within the power system 102. A computer having a CPU and data storage 133 controls and automates much of the power system 102. The computer is ideally connected to a wireless computer network 136 for communicating with external sources, such as a source providing weather data 138. Other sensors may be connected to the computer, such as a daylight sensor 134 for indicating when sunlight is present and a proximity sensor 132 for detecting the presence of persons in proximity to the container 104. The proximity sensor may be a motion sensor, sound sensor, or some variation or combination thereof. The proximity sensor and daylight sensor may also be replaced by external sources transmitting data through the wireless network 136 to the computer CPU 133.

The purpose of the computer 133 is to control when the solar panel array 115 is deployed or retracted into the container. To prevent damage from weather, tampering, theft, or other negative actions, the system is automated to retract the solar panel array 115 in a variety of circumstances.

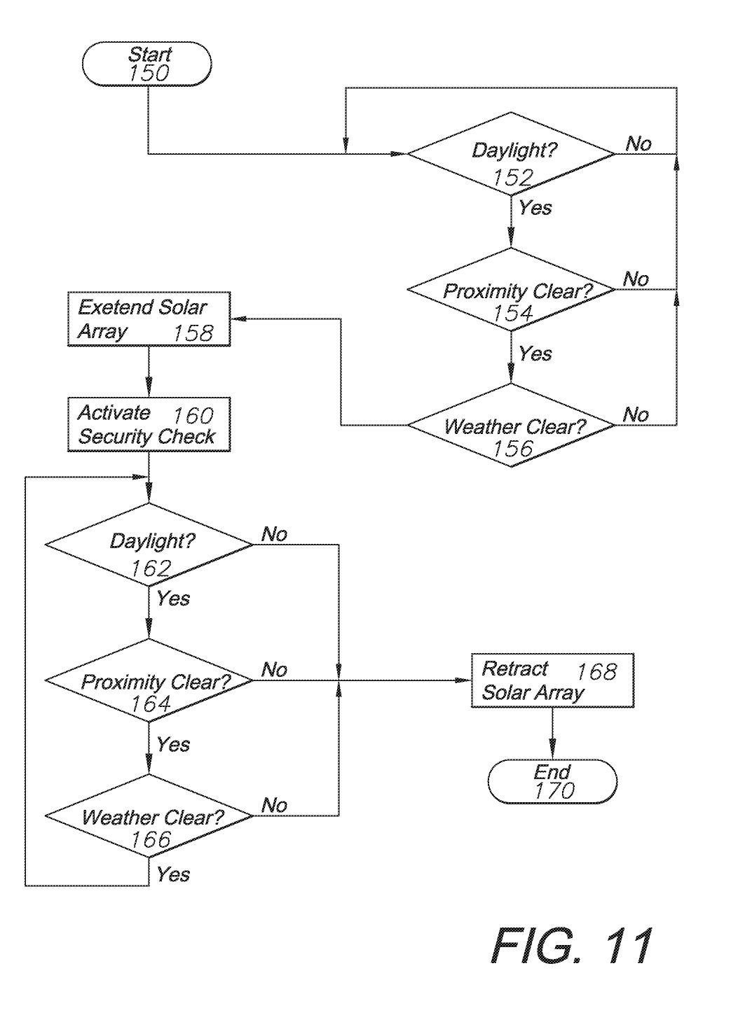

FIG. 11 shows the steps required for practicing the automated portions of the present invention, preventing the damage and theft as discussed above. The process starts at 150. The computer receives information from sensors or other third party sources via the wireless network to check to see if there is sunlight at step 152. If there is sunlight, the system will check to make sure the proximity is clear at 154. This step detects for potential threats of theft or vandalism. If there are no threats, the system checks the weather to make sure there is no potential for storms that may damage the array at 156. If any of these three checks fail, the system continues checking until all required checks are satisfied. Other checks may also be employed.

If all of the checks are passed, the solar array is extended at 158 and begins collecting solar energy and creating power. The computer then activates a security check at 160. Again, the computer will actively monitor for daylight at 162. When the sun is blocked or goes down, the solar array will retract at 168 and the process ends at 170. Similarly, if a threat is detected by the proximity sensor or other similar device at 164, the solar array retracts at 168 and the process ends at 170. Also, if the computer receives a weather report indicating potentially damaging weather approaching the container 104 at 166, the solar array automatically retracts at 168 and the process ends at 170. If no checks are negative, the security check continues monitoring the system 102.

### III. Alternative Embodiment or Aspect Transportable Hybrid Power System 202

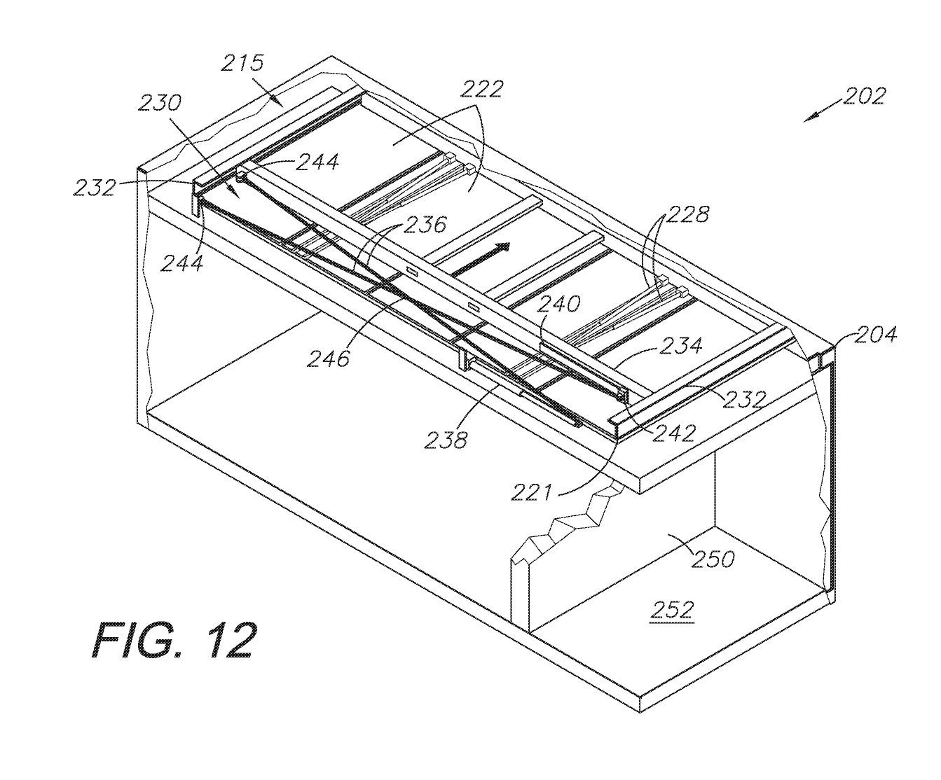

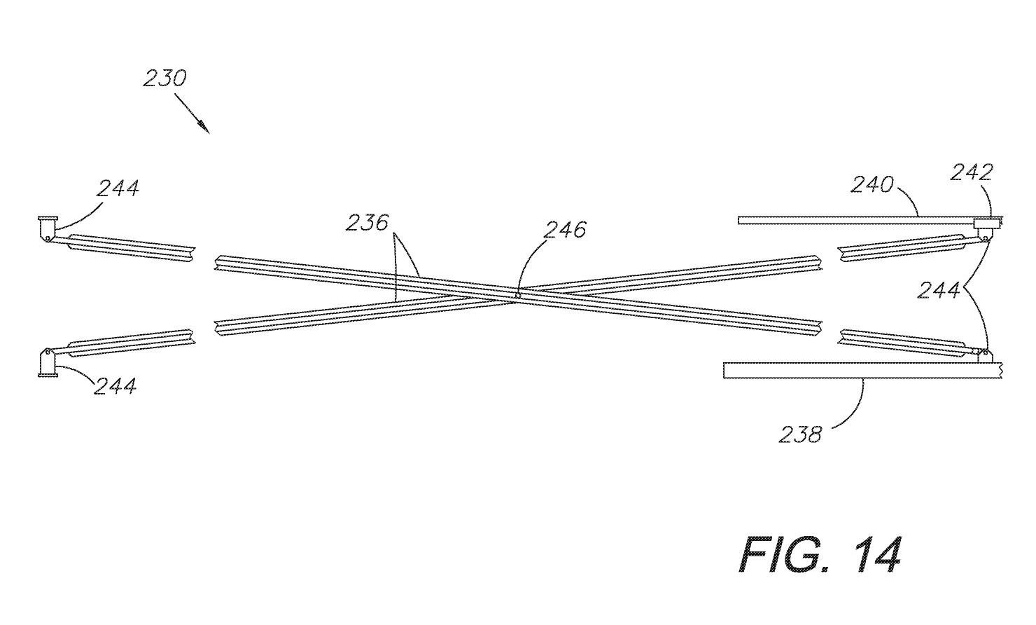

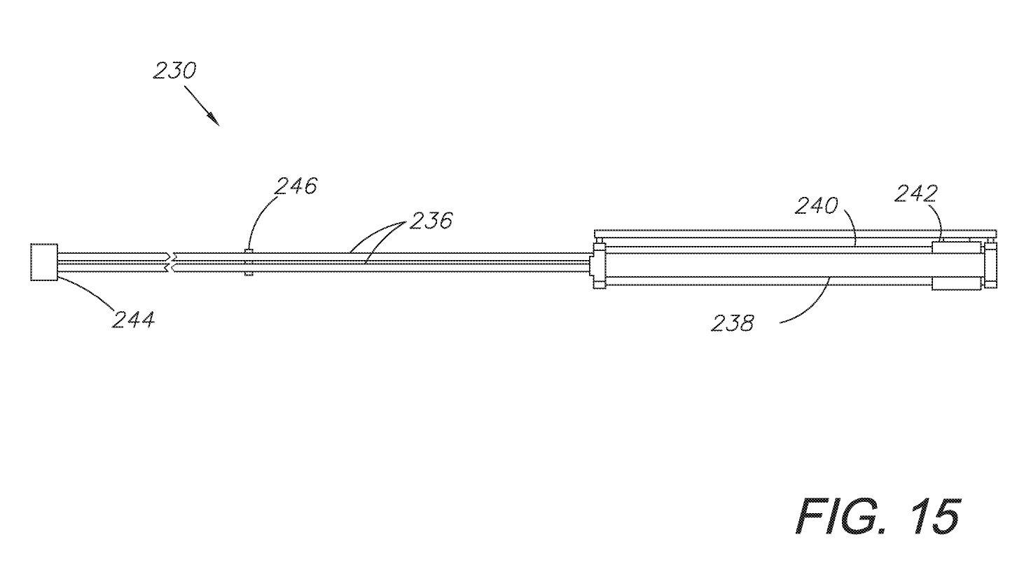

FIGS. 12-17 show yet another alternative embodiment hybrid power system 202 including a container body 204 housing multiple features and functions for producing or providing electrical power and other services at a remote location.

FIG. 12 shows a very similar hybrid power system 202 to the systems 2, 102 discussed above. A container 204 includes a solar panel array 215 including a frame 221 housing multiple solar panels 222 for deployment outside of the container 204 and storage within the container when not in use, such as during storms, at night, or during detected times of danger or security issues. Here, the solar panel array 215 is connected to a pair of structural beams 234 mounted along a pair of channel rails 232 which help to guide the entire structure into and out of the container 204. When the array 215 is outside of the container, the frames 221 and panels 222 can be positioned for optimal sunlight with the hydraulic arms 228 which move the solar panels to face the sun. This is very similar to the process discussed with the system 102 above.

A scissor lift assembly 230 operates to move the solar panel array 215 into and out of the container 204. This lift assembly only moves the array horizontally, after which the hydraulic arms 228 of the solar panel array 215 move the panels 222 into vertical orientation. The scissor lift assembly 230 connects to the container and structural beams 234 at four connector joints 244 which allow the ends of the scissor lift arms 236 to pivot freely. A central pin 246 connects the two scissor arms 236 at a central location to allow the two arms to scissor about that point. One end of one scissor arm 236 is connected to a hydraulic arm 238 which powers the scissor lift 230. The opposing end of the other scissor arm 236 connects to a slide 242 which is engaged with a rail 240, allowing the scissor arm to slide along the rail as the solar panel array 215 is pushed out of the container 204. This could also be used to provide an angular orientation to the solar panel array 215.

Also shown in FIG. 12 is an optional interior wall 250 which separates a contained room 252 within the interior of the container. This room may be used to store fuel tanks, generators, batteries, or other equipment which is separated for fire protection purposes or security purposes, limiting access to those items to only allowed personnel.

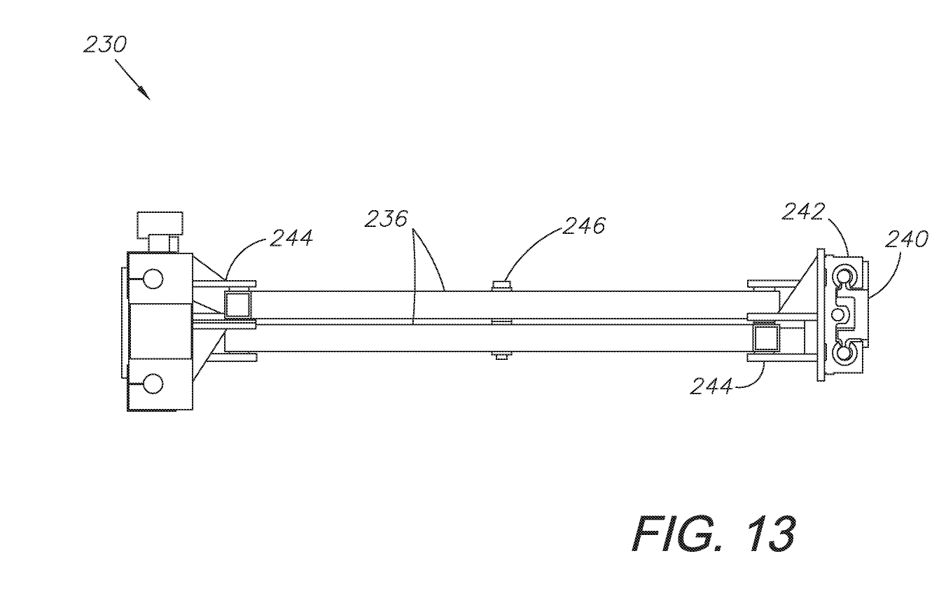

FIGS. 13-16 show the scissor lift assembly 230 in more detail.

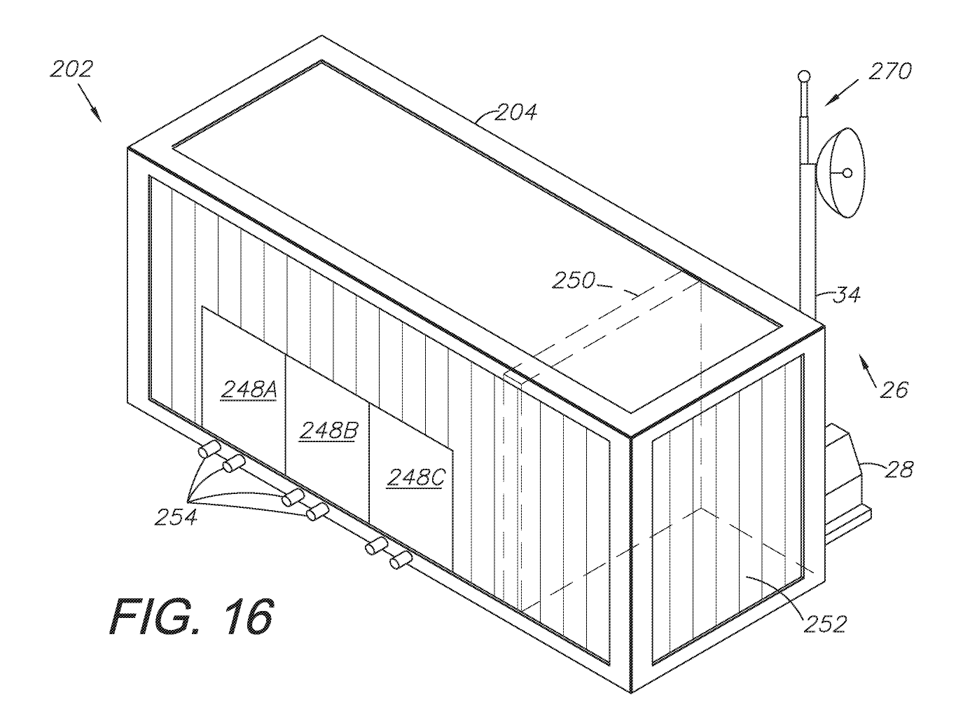

FIG. 16 shows an exterior view of the container 204, which is equipped with three alternative access doors 248A, 248B, and 248C, each with access conduits 254 for running cables or other services into and out of the container 204. Each door could be used by a separate entity utilizing the container system 202. For example, in telecommunications, there are several companies who may all wish to access the container 204, but who wish to keep their separate equipment secure and protected. Each company would then lease portions of the container and have secure access to only the equipment stored in that portion of the container, while maintaining security of the other companies' equipment. The side room 252 could again have even separate access from the entities that have access to the front doors 248A, 248B, 248C.

Also shown is the wind turbine subsystem 26 of the previous embodiments, shown here without the wind turbine 36 but instead with an antenna array 270 for surveillance or to deliver telecommunications data to or from the container system 202. Otherwise this assembly would be the same or similar to the system as discussed above.

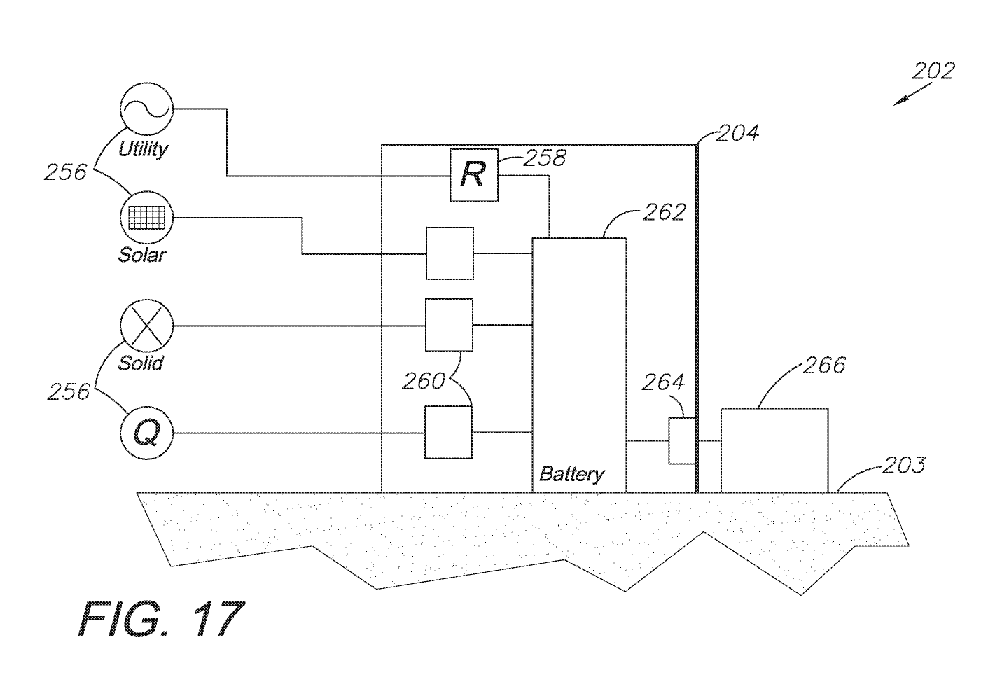

FIG. 17 shows a diagrammatic view of the container system 202 wherein multiple sources of power input 256, such as external utility power, external solar or otherwise renewable power, external solid fuel power (e.g. wood burning), or external fuel source power (e.g. diesel generator). The power enters receivers 258 or converters 260 within the container, where the power would be converted and stored into the batteries 262. This way the DC power can be accessed via an access port 264 which allows external equipment 266 to use the power when necessary, thereby providing reliable DC power for local uses in remote locations. As shown the container is placed on the ground 203, or may be elevated for security purposes.

### IV. Alternative Embodiment Hybrid Utility System 302

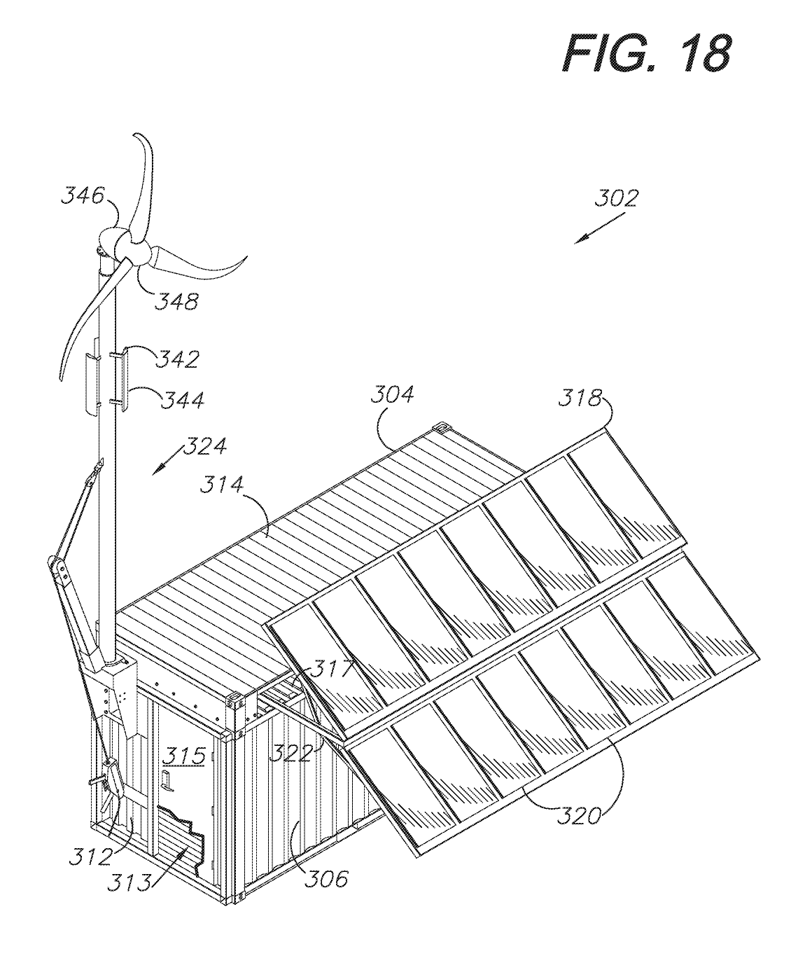

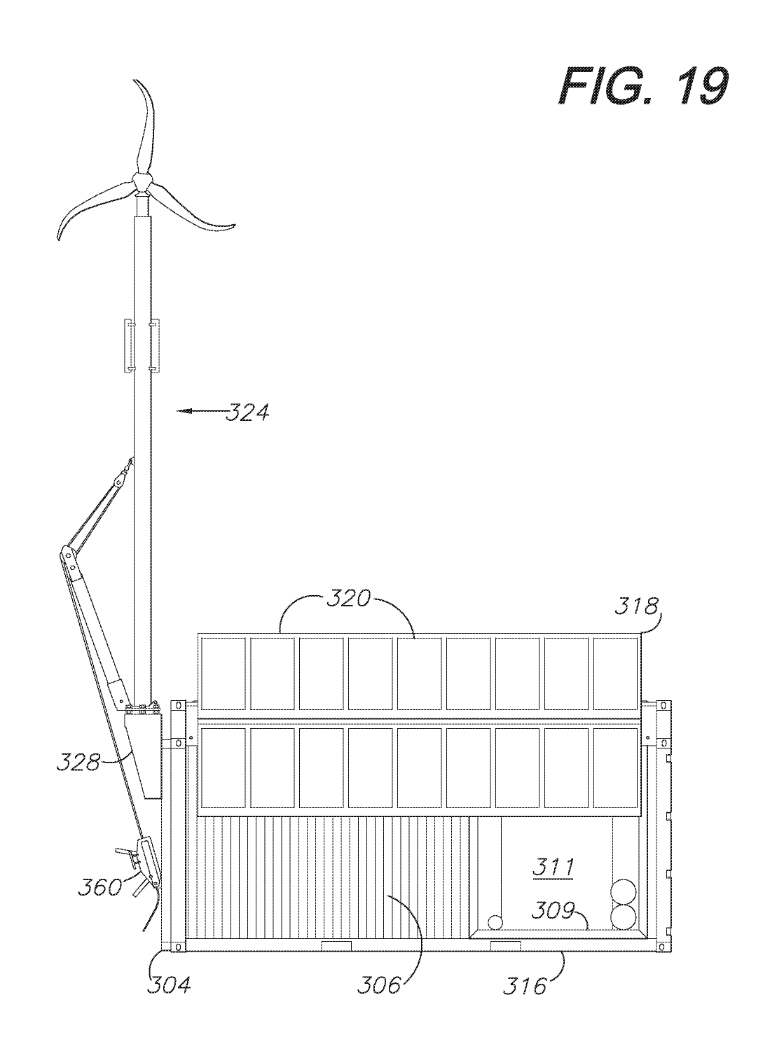

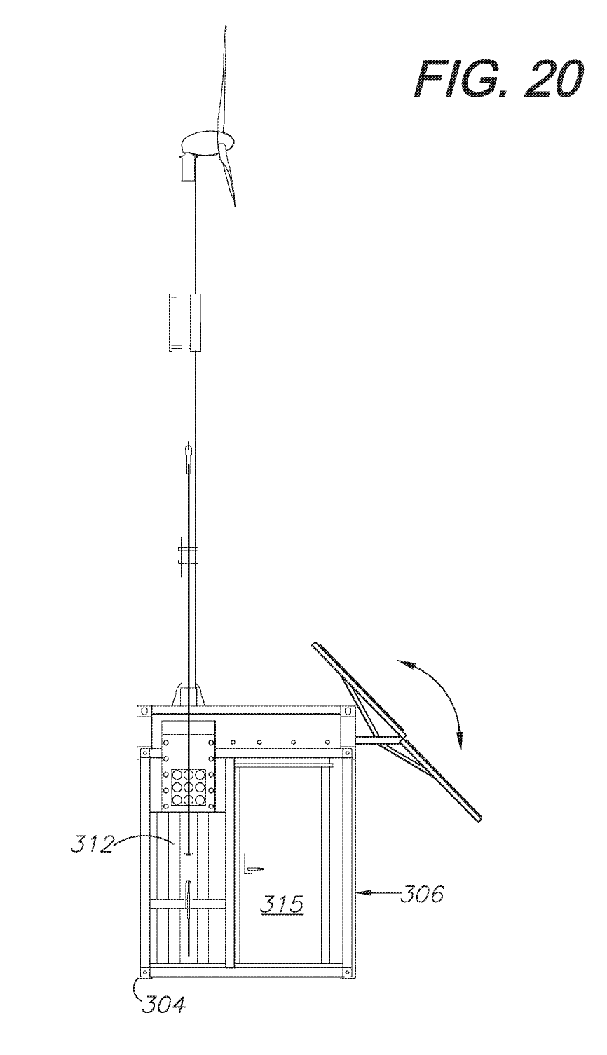

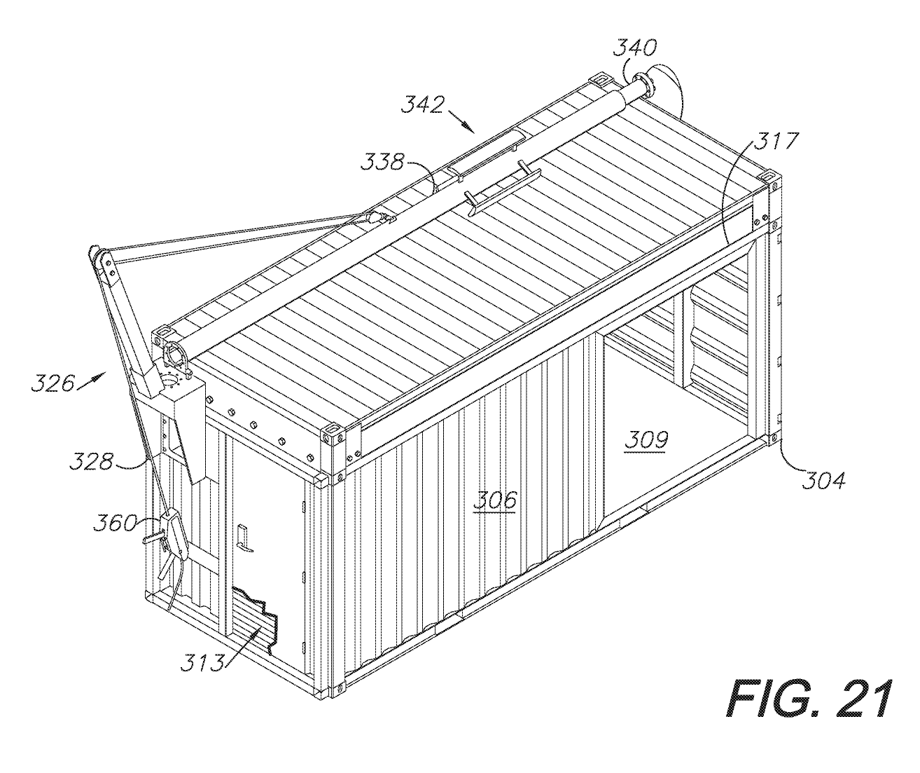

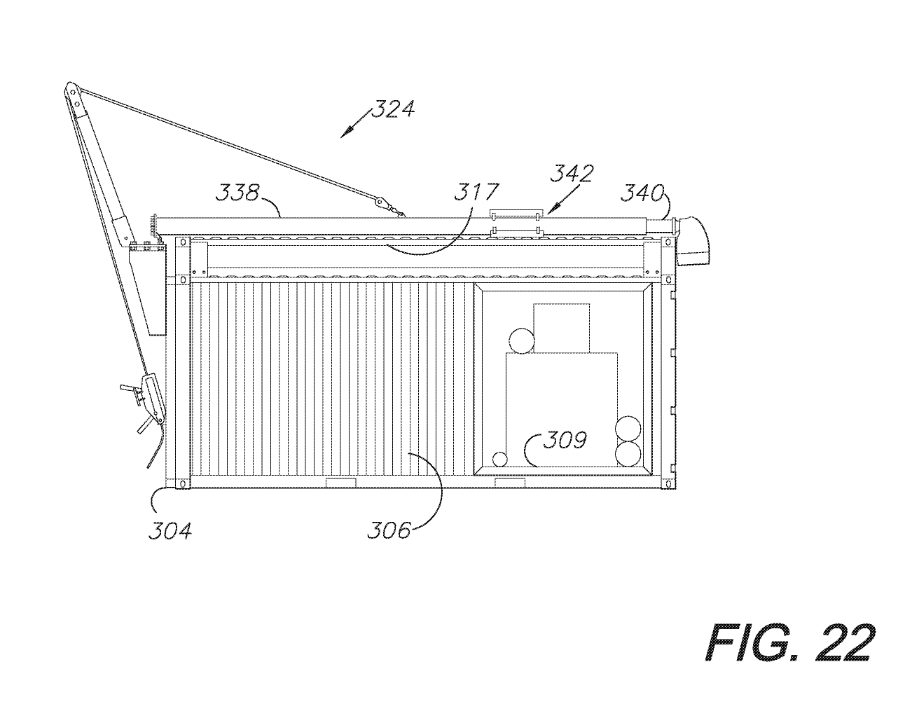

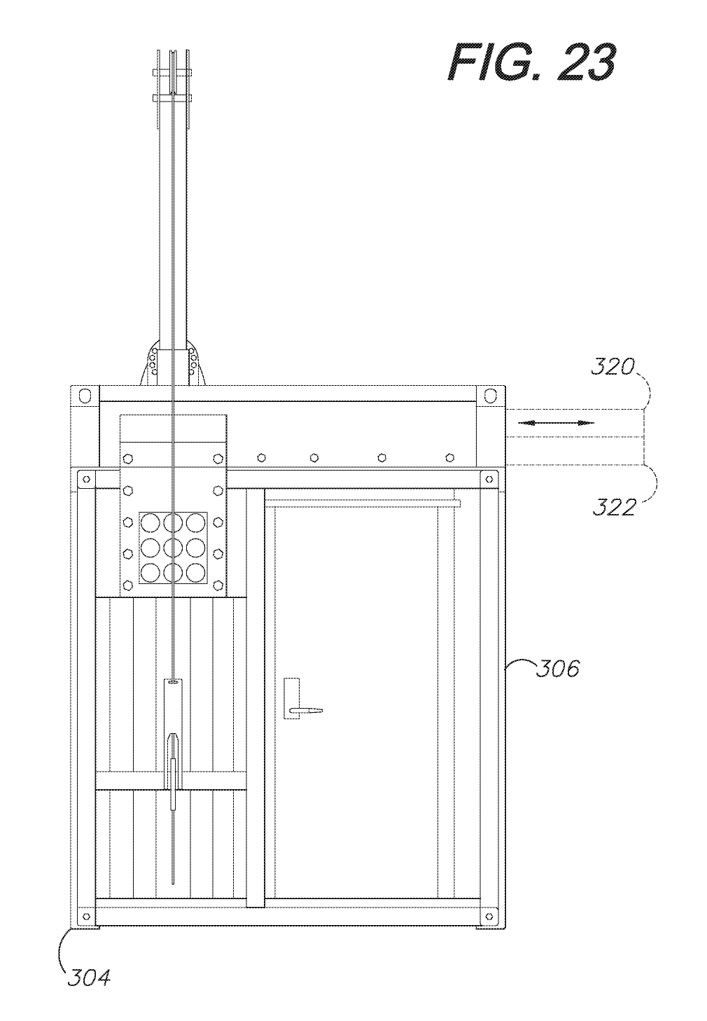

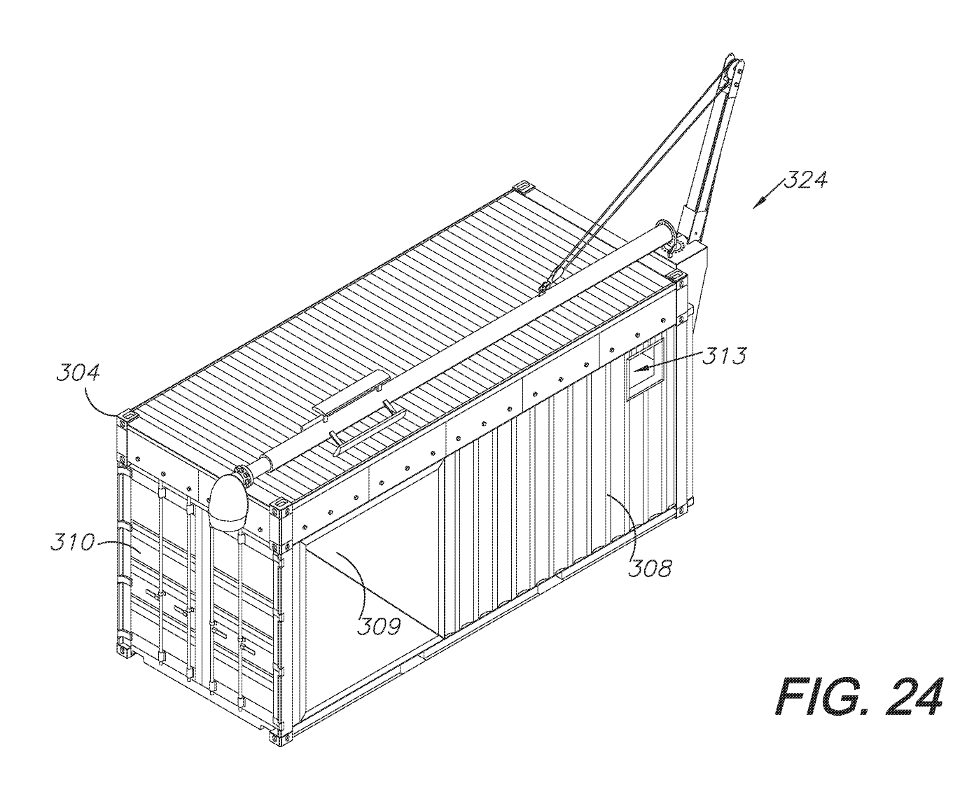

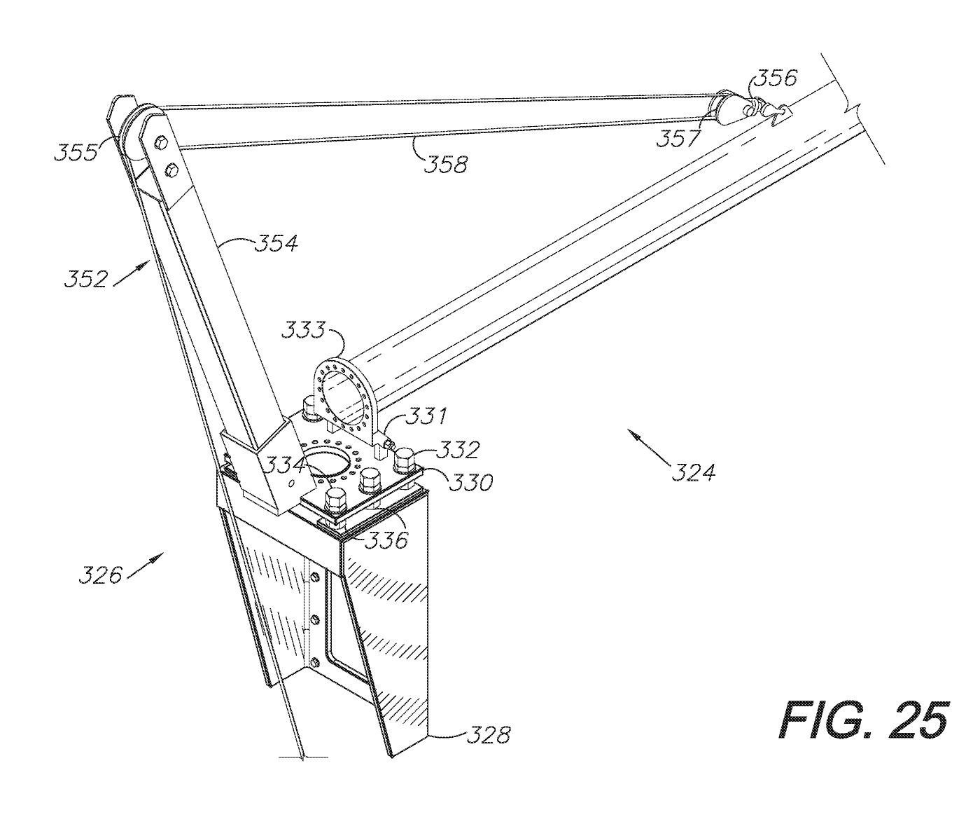

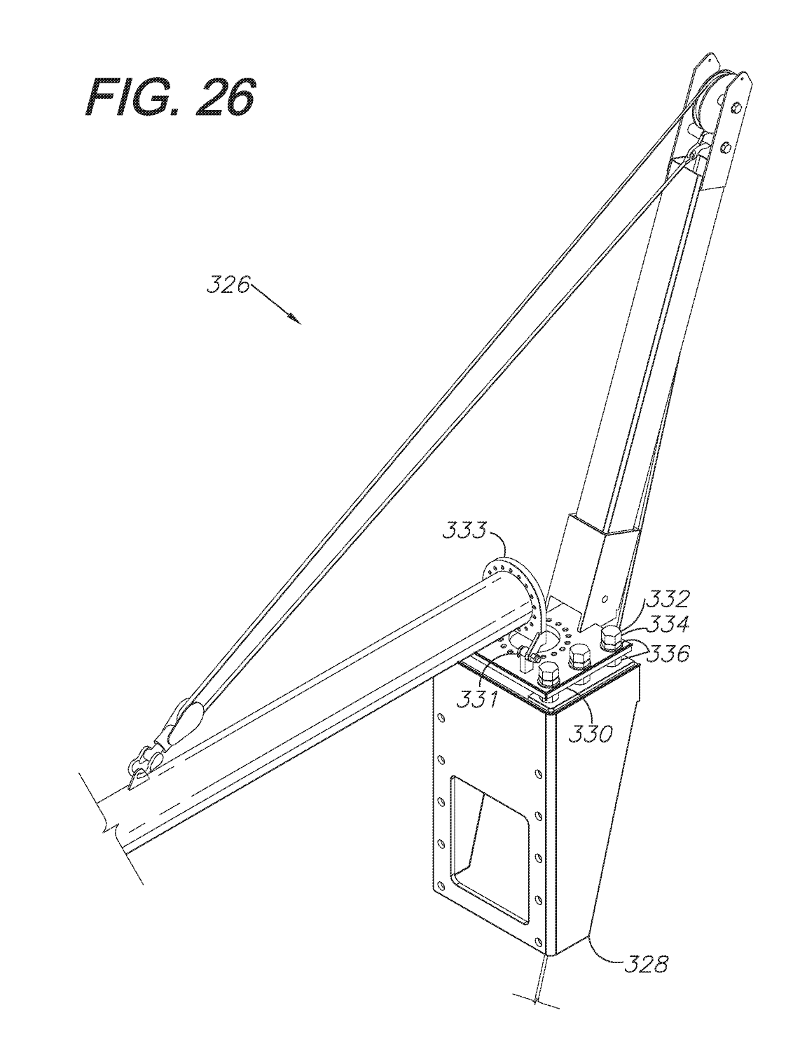

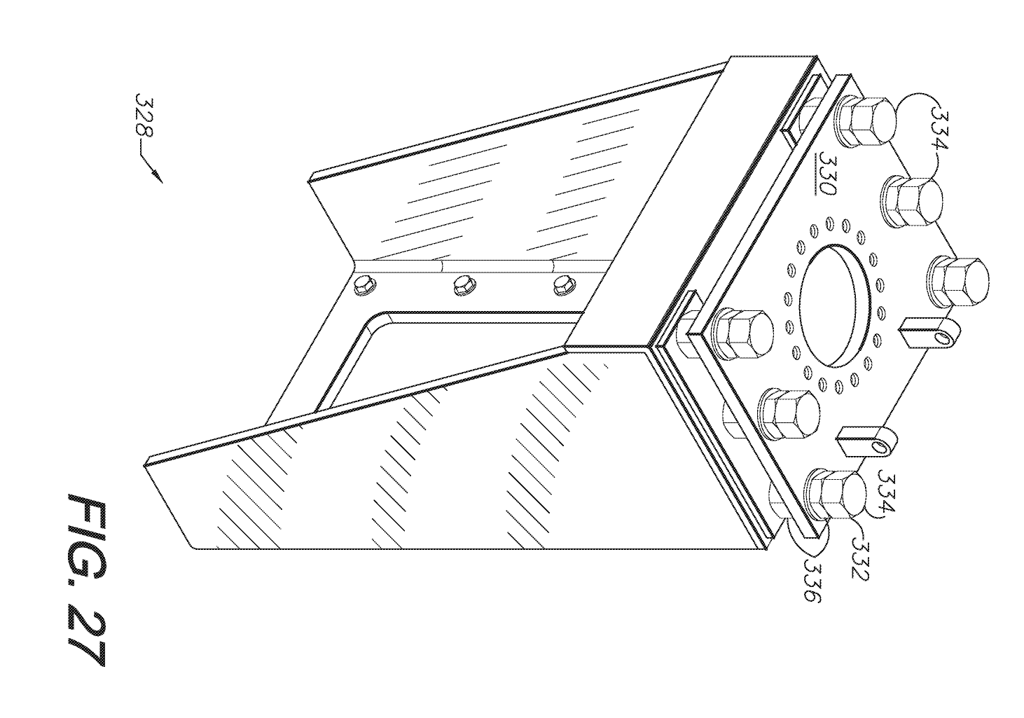

FIGS. 18-27 show another modified or alternative embodiment hybrid utility system 302 including a housing 304 with front and back sides 306, 308; right and left ends 310, 312; a top 314; and a bottom 316. The housing 304 includes a first (right) bay 309 and a second (left) bay 313. Equipment 311 can be installed in one or both of the bays 309, 313. The left bay 313 is accessible through a door 315. The bays 309, 313 can be equipped with a wide variety of components, equipment, supplies and other contents. For example, fuel tanks, electrical storage batteries, water-wastewater vessels and other contents can be stored therein.

The system 302 includes a “top hat” or top compartment 317 configured for storing a photovoltaic subsystem 318 with a panel array 320 and a panel frame 322. A mast assembly 324 is mounted on the housing left end 312 by a mounting subassembly 326, which includes a base bracket 328 mounting a mast base plate 330. The mast base plate 330 is attached to the base bracket 328 by multiple connectors 332, each including bolts 334 and nuts 336, which can be threadably adjusted for adjusting the orientation (tilt) of a vertical standard or mast 338 of the mast assembly 324. The vertical standard 338 mounts a mast bottom flange 333, which is configured for bolting onto the mast base plate 330.

The mast assembly 324 further includes a mast extension 340 mounted on top of the mast 338. Additional extensions 340 can be provided for optimizing the height of the mast assembly 324. An antenna array 342 is mounted on the mast 338 and includes multiple antennae (three are shown), which can receive microwave and radio frequency (RF) signals for telecommunications and other purposes.

The mast assembly 324 can be raised and lowered by a mast hoist subassembly 352, which includes a pulley bar 354. A cable 358 can be extended and retracted by a winch 360, and extends over a first pulley 355 and a second pulley 357 mounted on the mast 338 by a pulley connector 356.

### VI. Alternative Embodiment Hybrid Utility System 402

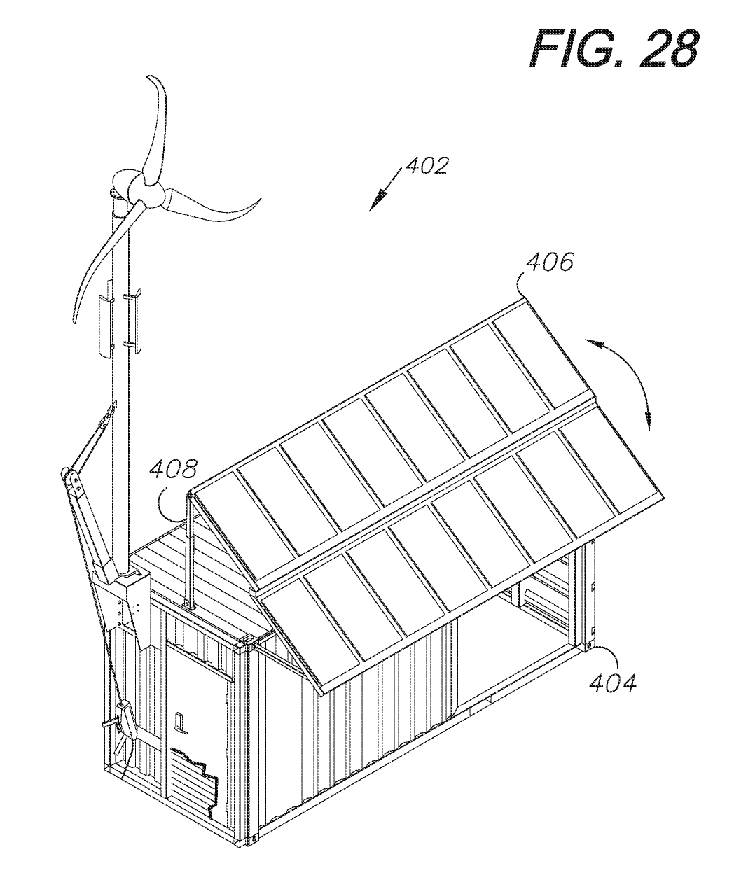

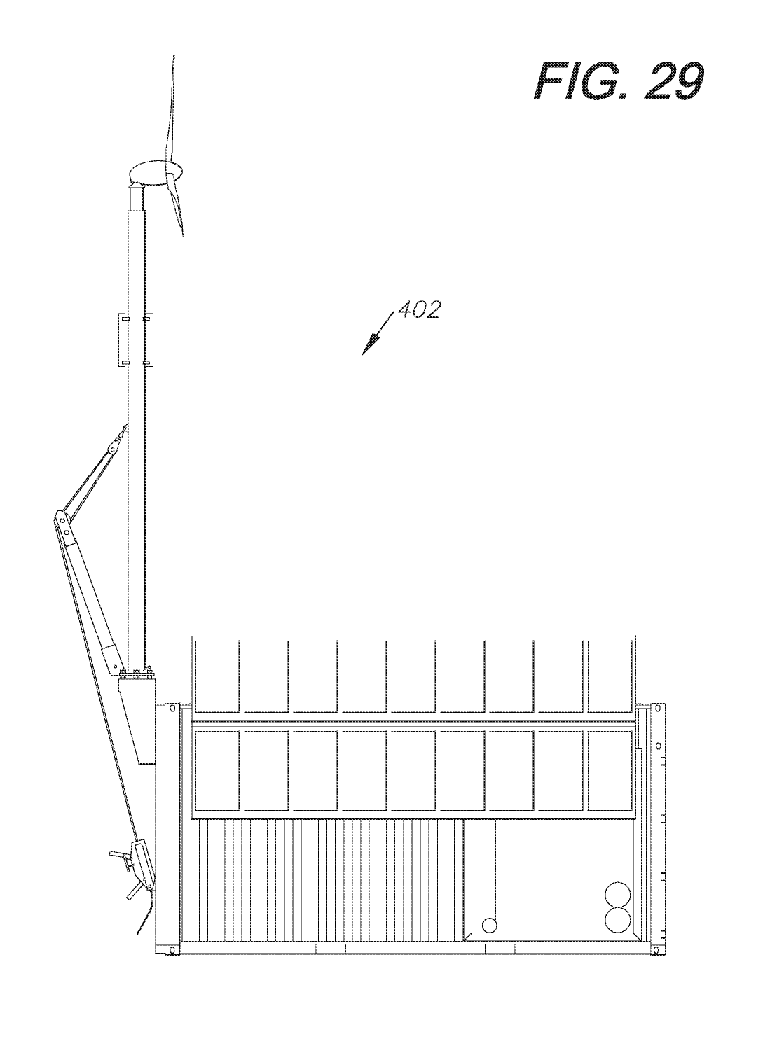

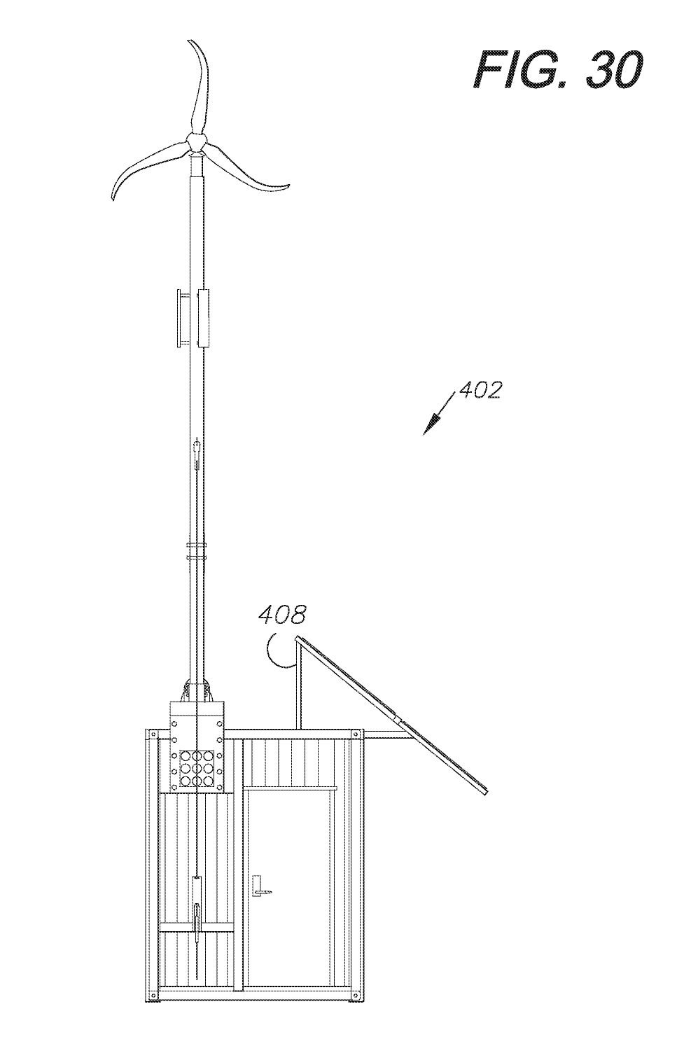

FIGS. 28-30 show a hybrid utility system 402 comprising another alternative or modified embodiment of the present invention with a container housing 404 mounting a photovoltaic array 406 with a mounting support 408 attached to the top of the housing 404. The mounting support 408 can accommodate repositioning and reorienting the photovoltaic array 406.

### VII. Alternative Embodiment Hybrid Utility System 452

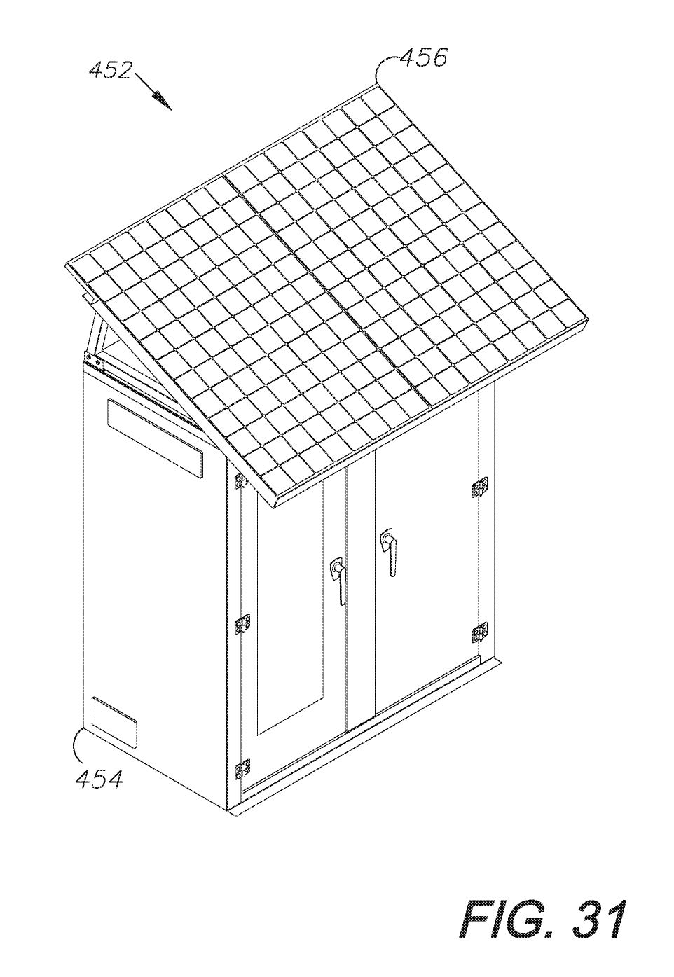

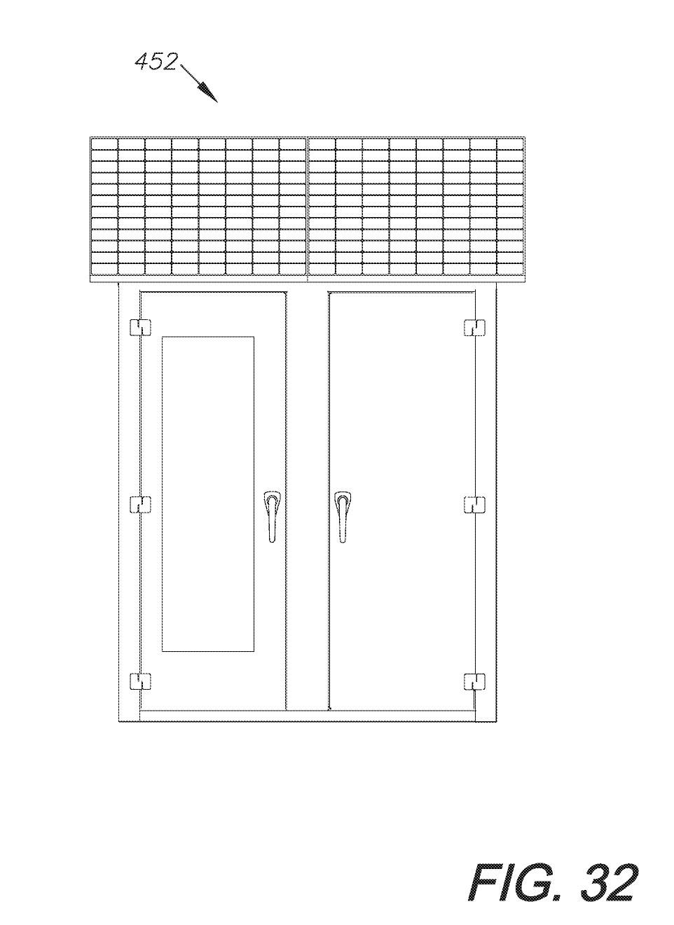

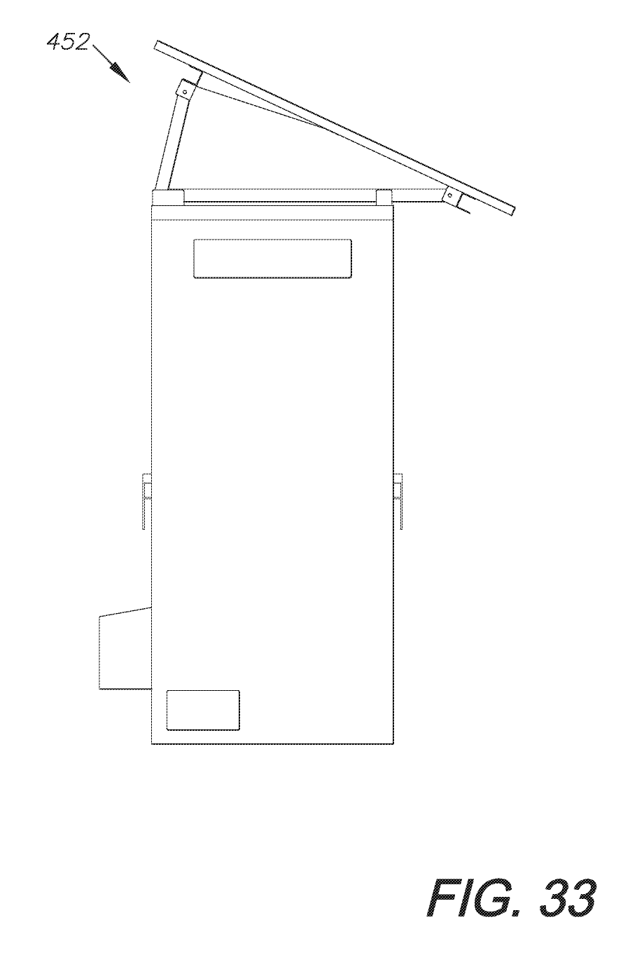

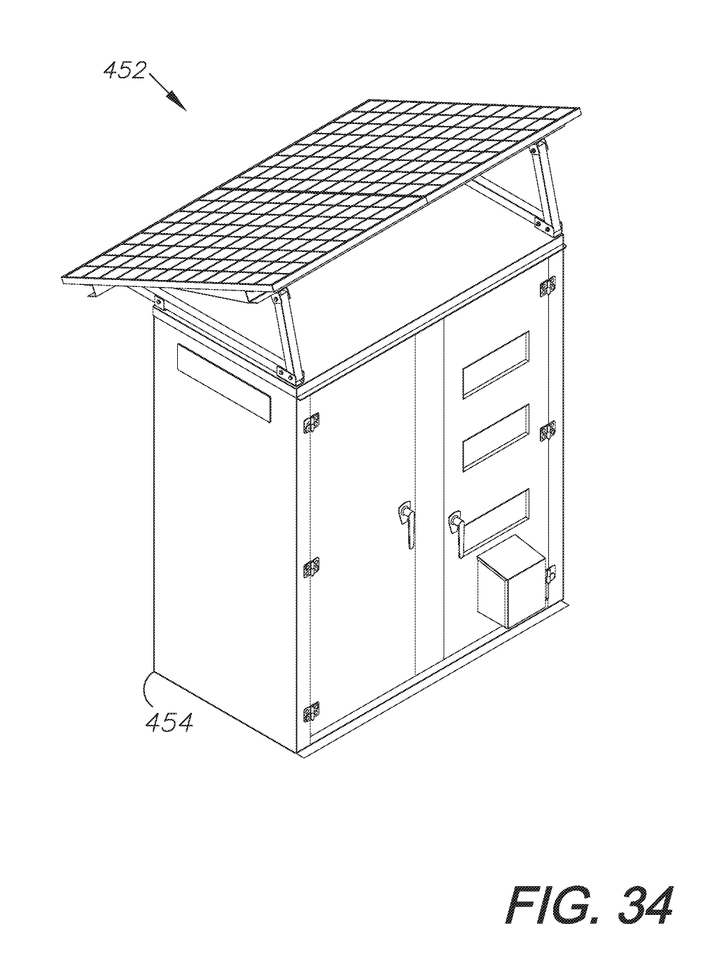

FIGS. 31-34 show another modified or alternative embodiment hybrid utility system 452 including a cabinet 454 mounting a photovoltaic array 456. The cabinet 454 can be scaled as appropriate for various applications. A variety of utility components, supplies, storage batteries, fuel sources and other contents can be placed in the cabinet 454.

### VIII. Alternative Embodiment Hybrid Utility System with Clamping Connector 502

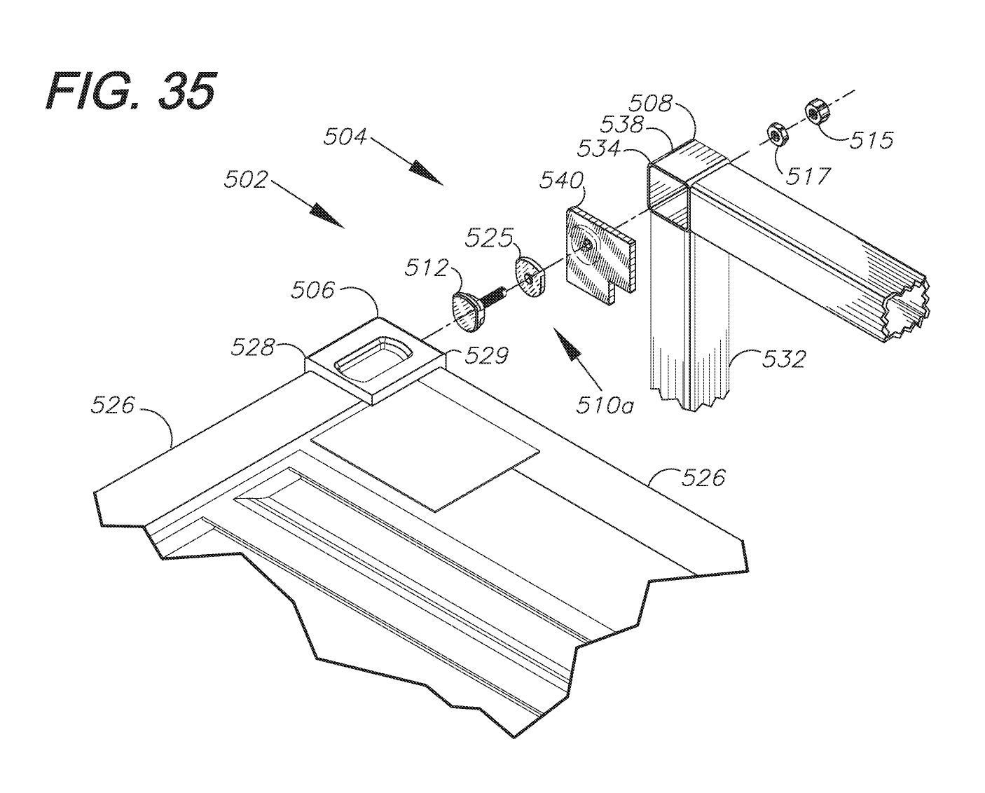

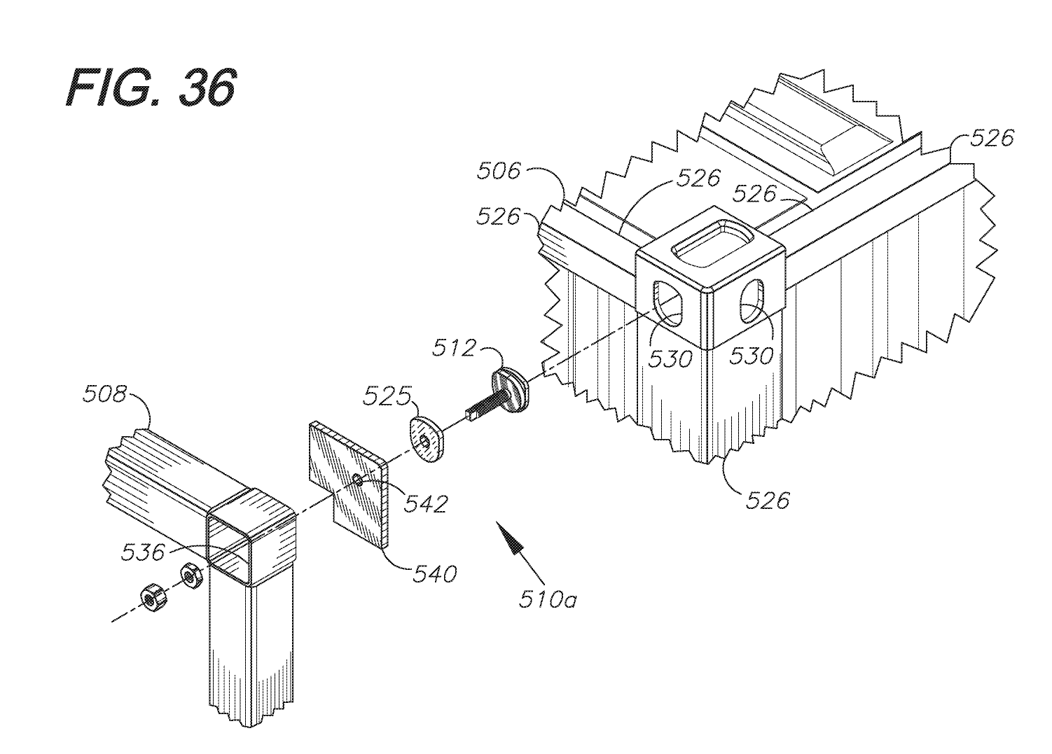

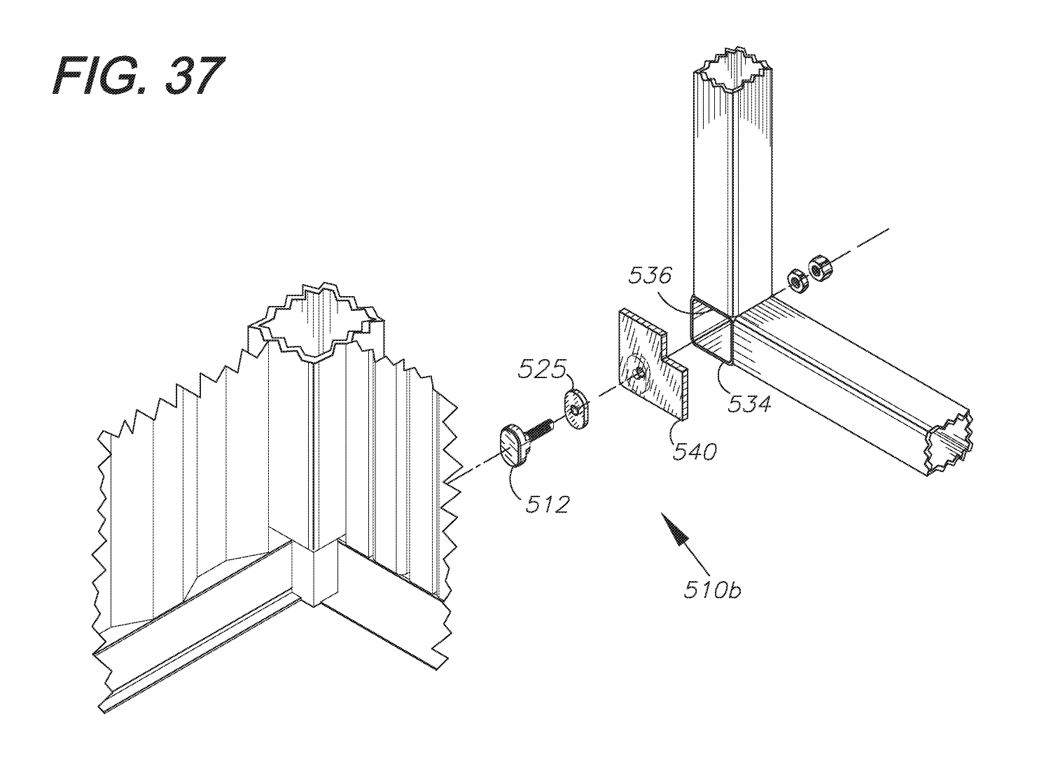

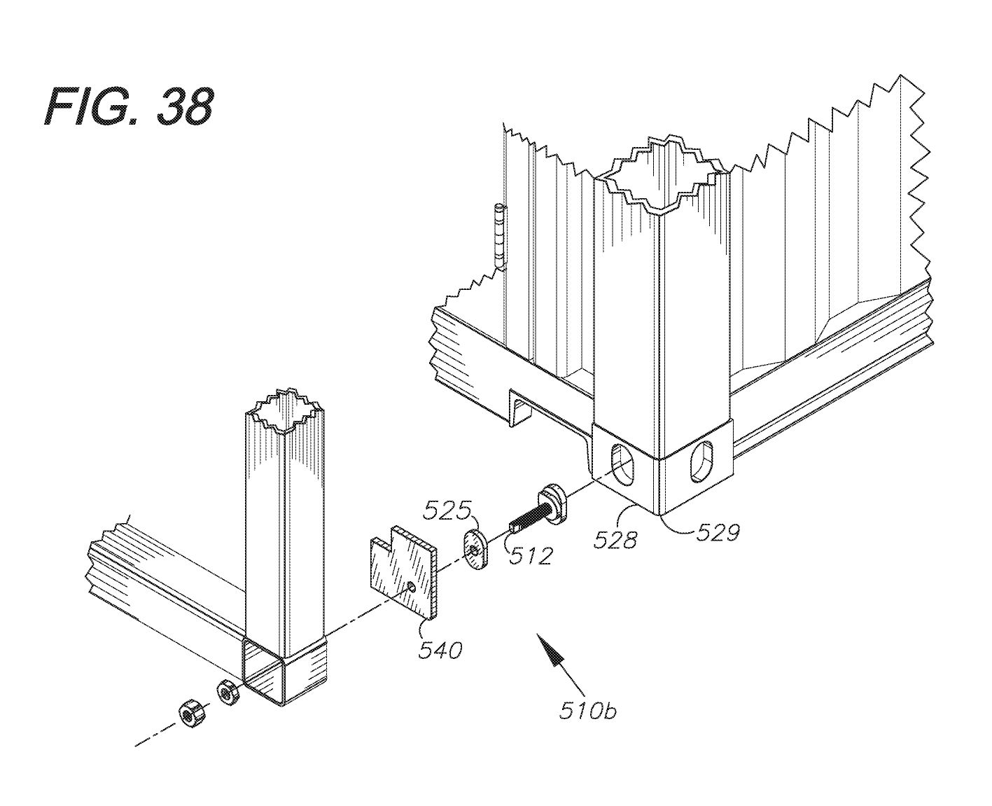

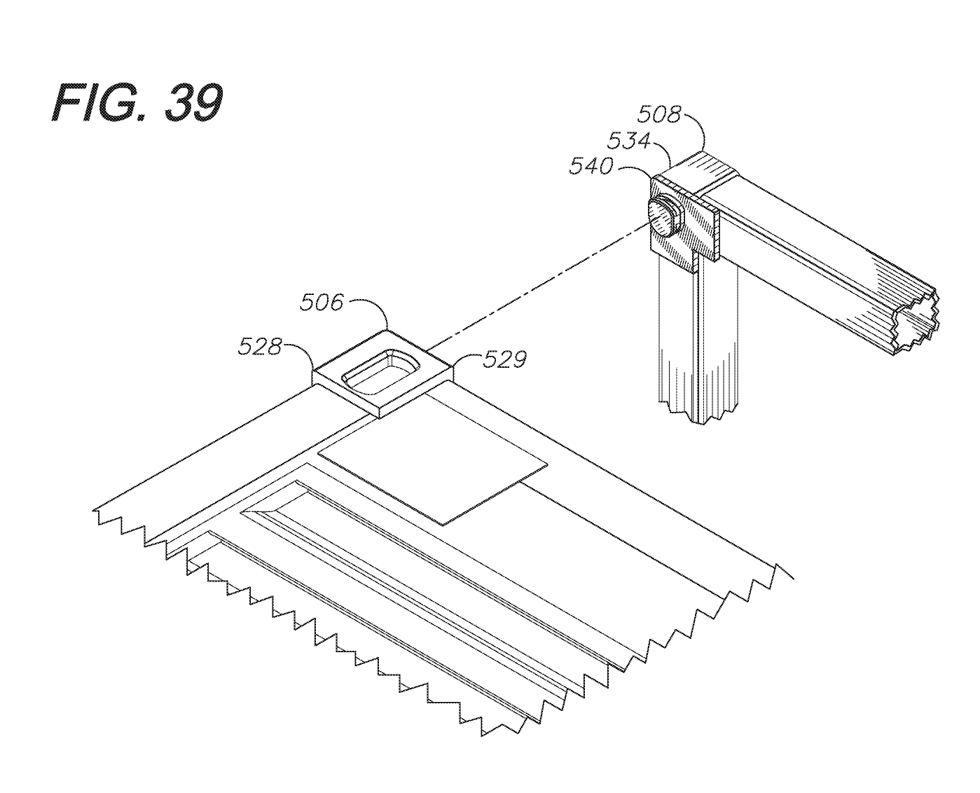

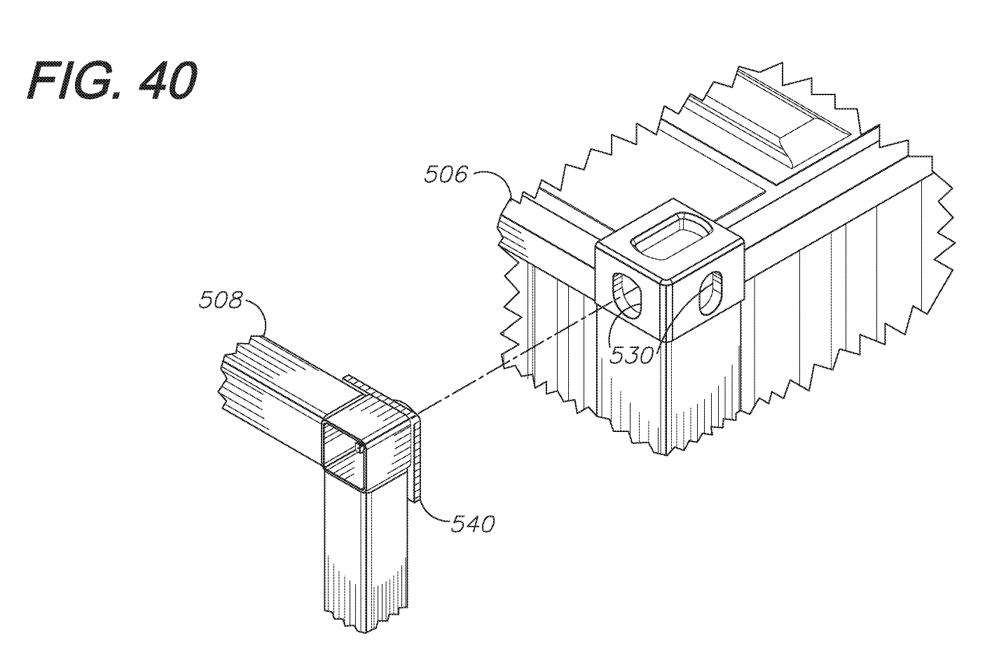

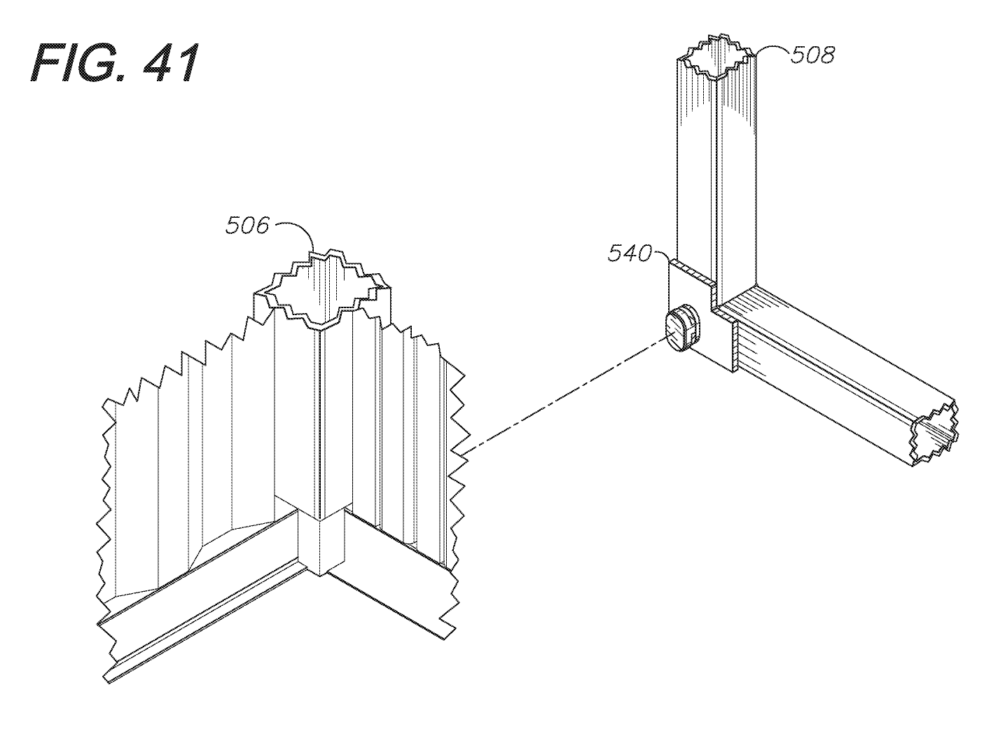

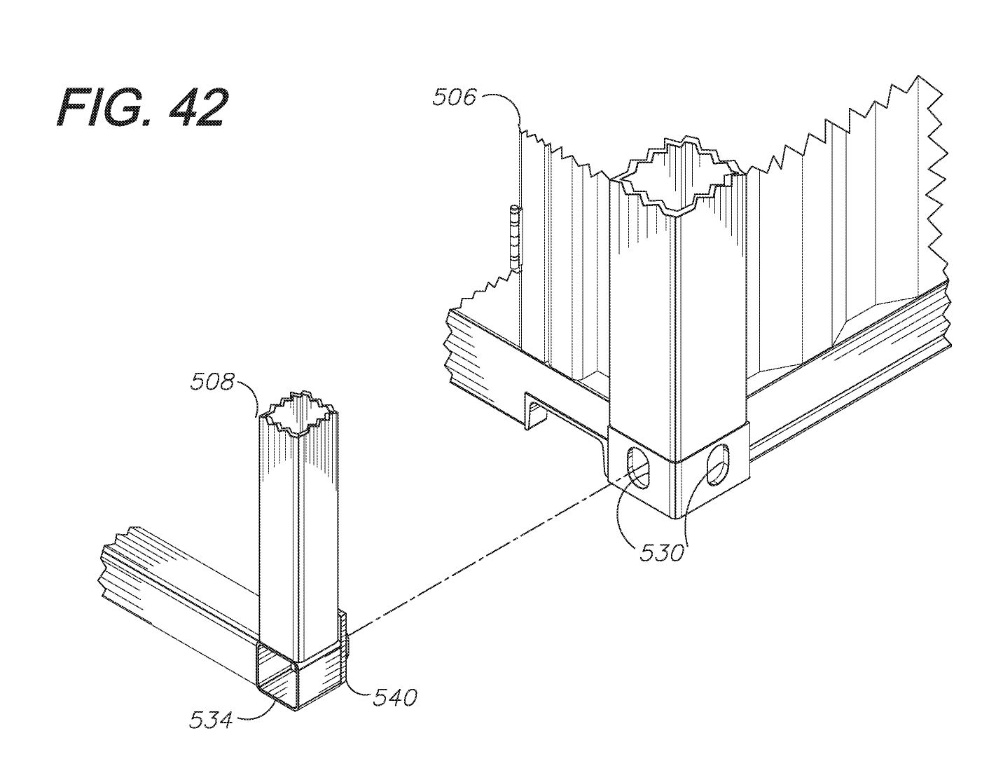

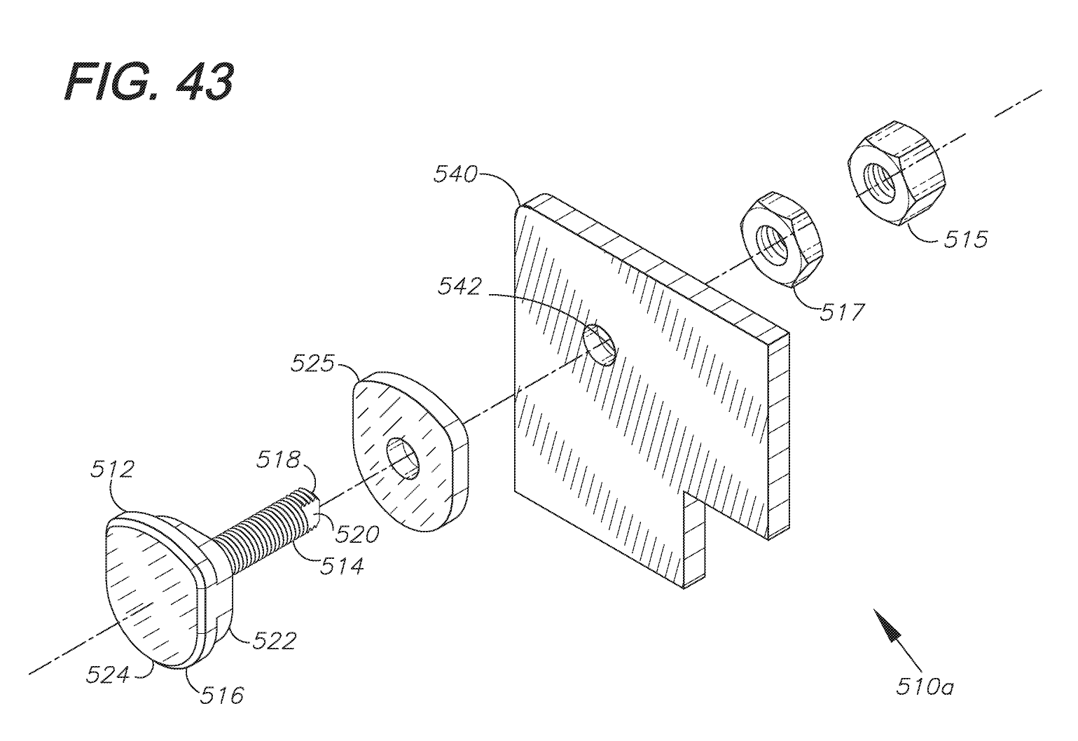

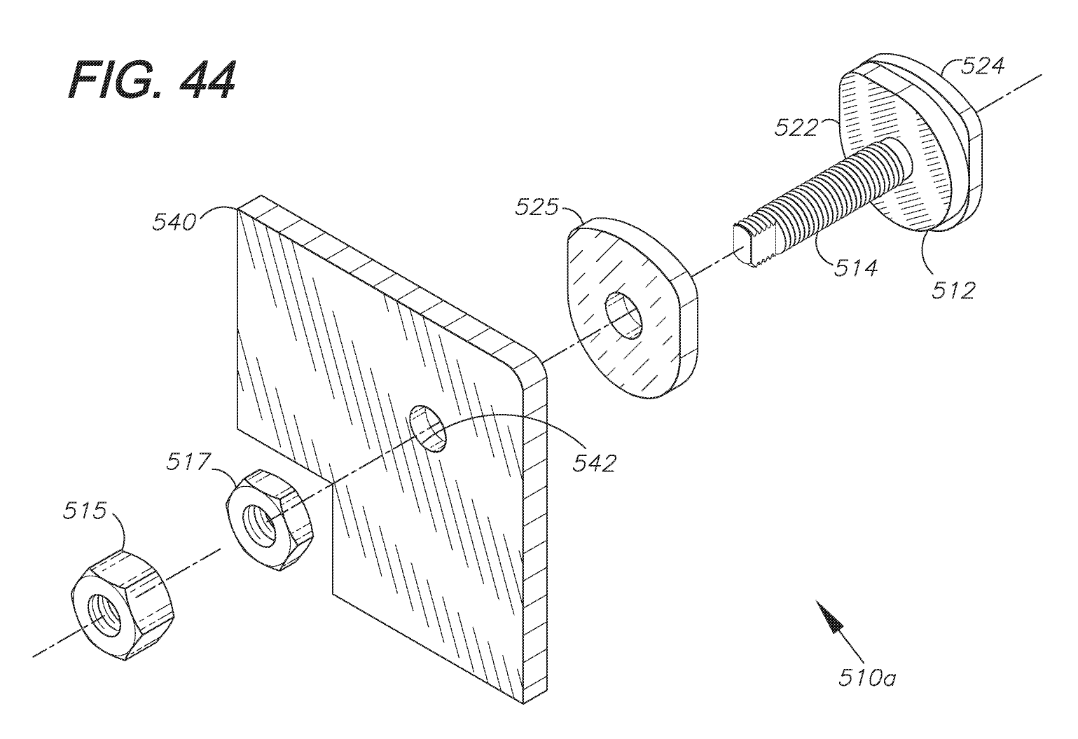

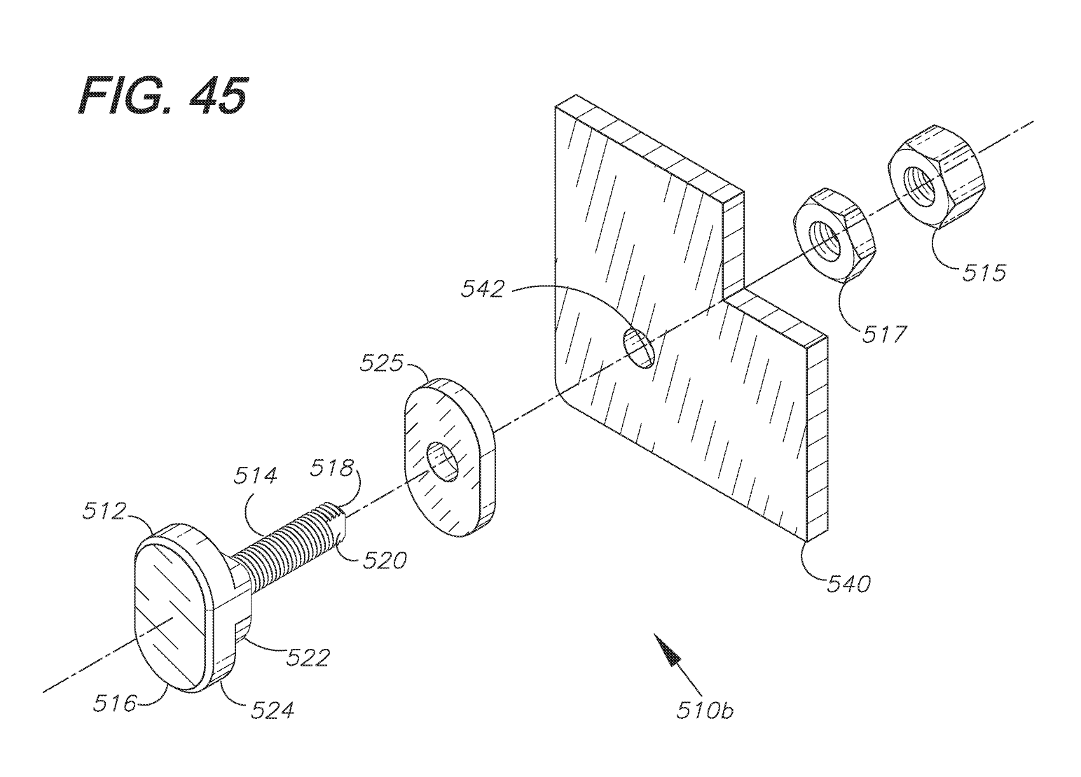

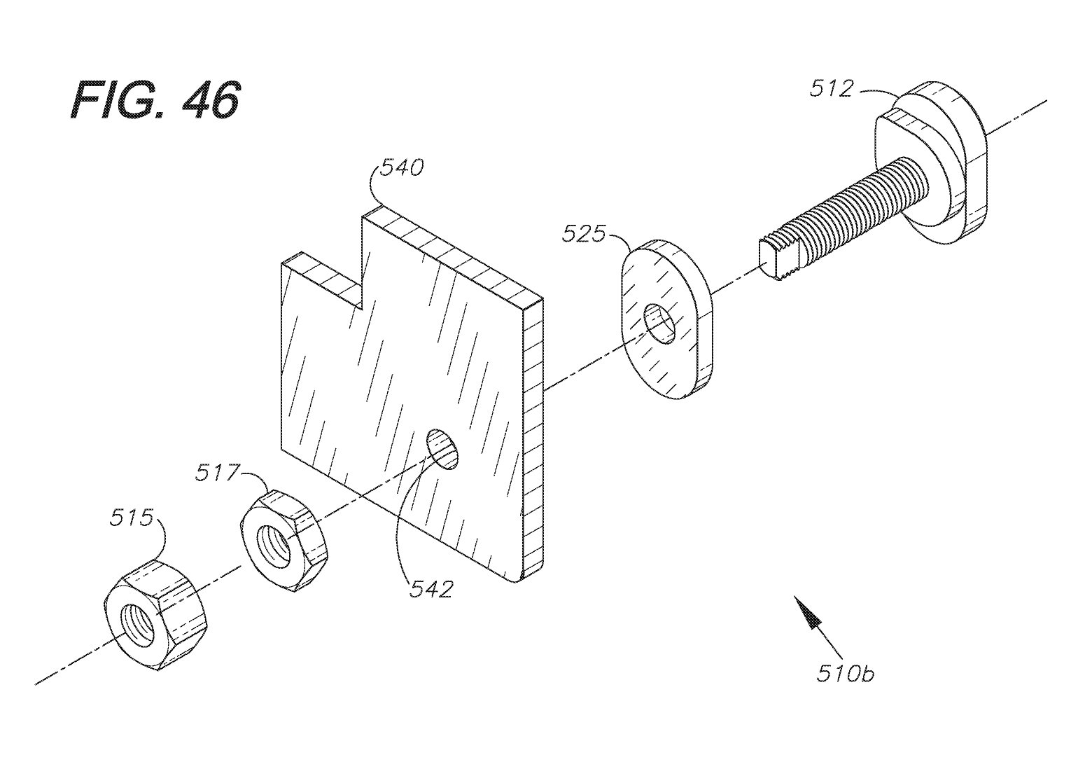

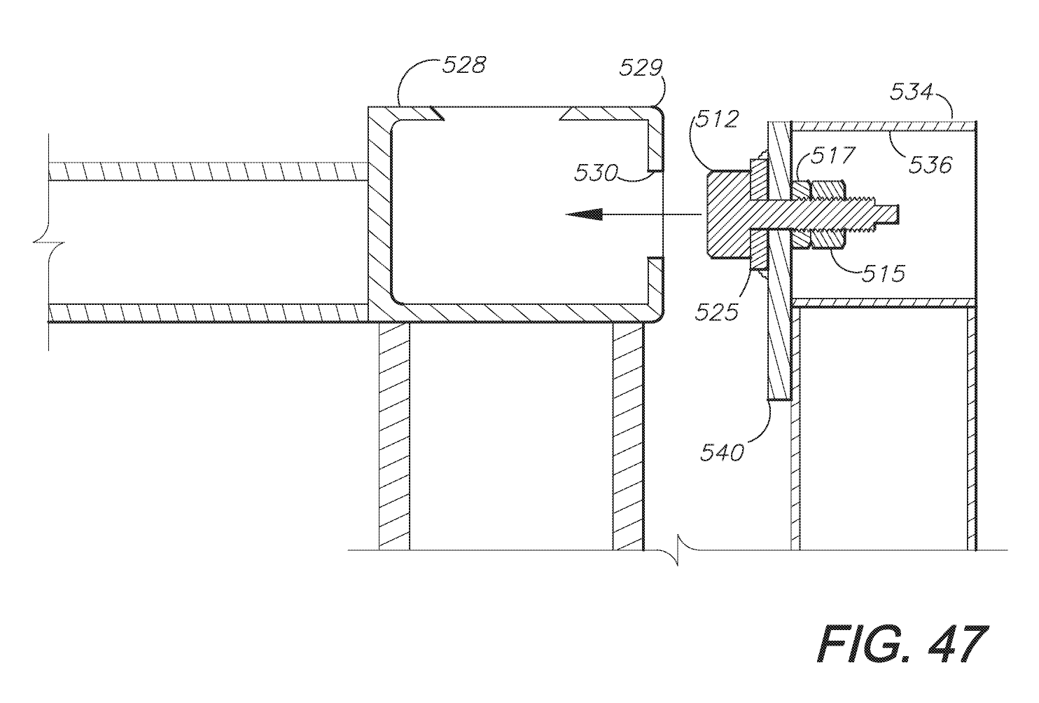

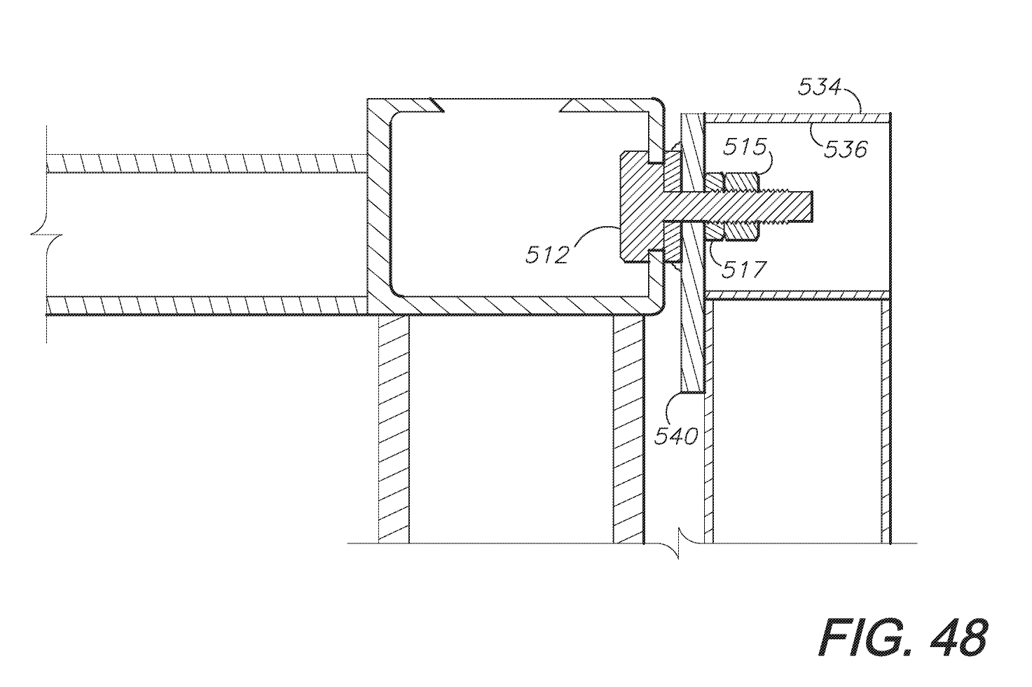

FIGS. 35-48 show another modified or alternative embodiment hybrid utility system 502 with a frame 504 comprising a main frame 506 mounting a subframe 508 with upper and lower clamping connectors 510a,b, which are also adapted for releasably connecting housings 304, e.g., in tandem side-by-side, aligned end-to-end, and other configurations.

Each clamping connector 510a,b includes a bolt 512 with a threaded shaft 514 including a distal end 518 with flats 520. A bolt head 516 includes a proximal spacer 522 mounted on the threaded shaft 514 and a distal, enlarged anchor 524. A washer 525 receives the shaft 514. In the example shown, the main frame 506 includes main frame legs 526, which terminate at main frame junctions 528 at main frame corners 529. Each main frame junction 528 includes connector receivers 530, which are generally oblong and configured to receive a bolt head 516. A washer 525 has a similar configuration to the bolt head 516 and receives the shaft 514.

The subframe 508 includes subframe legs 532 terminating at and attached to junction sleeves 534, which include passages 536 extending generally between opposite faces of the subframe 508. Each subframe corner 538 includes an L-shaped plate 540 including a bolt hole 542 and fastened to an inner end of a respective junction sleeve 534.

The clamping connectors 510a,b facilitate quickly and efficiently assembling the frame 504. For example, the clamping connector bolts 512 and the washers 525 can be mounted on the subframe corners 538 pre-assembly. The subframe 508 can then be placed adjacent to the main frame 506. The bolt heads 516 are placed in the connector receivers 530. The bolts can be rotated approximately 90° from released to locked positions by gripping their respective distal end flats 520. In their locked positions, the bolt head anchors 524 engage the inner faces of the main frame junctions. The connector and blocking nuts 515, 517 can then be tightened on the bolt shafts 514 for clamping the subframe 508 on the mainframe 506. The clamping connectors 510a,b can be secured and released from the outer face of the subframe 508. This operational feature enables clamping the connectors 510a,b with minimal effort by a single installer. Moreover, safety is enhanced by eliminating the need to access both sides of the clamping connectors 510ab. For example, the bolts 512 can be rotated with a tool engaging the distal ends 518, and the nuts 515, 517 can be tightened with ratchet wrenches mounting sockets, all exteriorly to the subframe 508.

The clamping connectors 510a,b can be used for other applications, such as connecting multiple mainframes, mounting other components on the frames 506, 508, and various other applications involving clamping and connecting functions.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A transportable utility system comprising:
a housing with an enclosed interior;
a photovoltaic solar array mounted on said housing and movable between a use position external to said housing and a storage position within said housing interior; and
a wind turbine power subsystem including: a mast assembly connected to said housing; and a wind turbine mounted on said mast assembly.

2. The system of claim 1 wherein said mast assembly includes:
a mast with proximate and distal ends;
a mast mounting subassembly including a bracket pivotally connecting said housing to said mast assembly; and
a mast hoist subassembly connected to said housing and said mast and configured for raising said mast from a lowered position adjacent to said housing today raised position extending from said housing.

3. The system of claim 2, which includes:
said solar array comprising first and second panels hingedly interconnected;
said solar array panels being generally coplanar in a use position and one panel overlying the other panel in said storage position.

4. The system of claim 1 wherein said wind turbine includes a wind sail.

5. The system of claim 1 wherein said wind turbine includes multiple rotor blades.

6. The system of claim 2 wherein said mast hoist subassembly includes:
a mast hoist subassembly bracket mounted on said housing;
a winch mounted on said bracket; and
a cable connected to said winch and said mast, said winch being configured for retracting and extending said cable whereby said mast is respectively raised and lowered.

7. The system of claim 1 wherein said mast assembly includes a telecommunications antenna array mounted thereon.

8. The system of claim 1, which includes:
a computer control system with Internet (worldwide network) access;
sensors mounted on said wind turbine power subsystem and said photovoltaic subsystem for monitoring performance; and
controls connected to said wind turbine power subsystem and said photovoltaic system for adjustably positioning same on said housing in response to information derived from the Internet and performance information.

9. The system of claim 1, which includes a rechargeable electrical storage battery mounted in said housing interior and connected to said wind turbine power subsystem and said photovoltaic system.

10. The system of claim 1, which includes fuel and water resources in said housing.

11. A transportable utility system comprising:
a container enclosing an interior space;
a photovoltaic solar array;
wherein said container interior space is configured to contain a power source;
a deployable solar array assembly comprising a plurality of solar panels, half of said plurality of solar panels being affixed to an upper structural frame thereby comprising a top array, and another half of said plurality of solar panels being affixed to a lower structural frame thereby comprising a bottom array;
said solar array assembly mounted on tracks within said container interior space;
a panel affixed to said container, said panel configured to move relative to said container, thereby providing an opening in said container;
a scissor lift assembly comprising two arms pinned at a central point, wherein a first end of each of said two arms is connected to said solar array assembly and a second end of each of said two arms engages internal structural elements of said container interior space;
said scissor lift assembly configured to move said solar array between a first, stored position within said container and a second, exposed position exterior from said container along said tracks, whereby said solar array passes through said opening;
an upper actuator arm configured to move said top array from a first, generally horizontal orientation to a second, deployed orientation;
a lower actuator arm configured to move said bottom array from a first, generally horizontal orientation to a second, deployed orientation; and
wherein said deployed orientations of said top array and said bottom array are configured based upon receiving optimum solar exposure.

12. The system of claim 11, further comprising:
a plurality of power sources selected from the group consisting of a wind turbine, a solar panel array, a hydrogen fuel cell, a fuel reformer, a battery, a gasoline generator, and a diesel generator.

13. The system of claim 11 further comprising:
a computer having a CPU and data storage, said computer configured to communicate with remote data sources; and
said computer configured to control the deployment of said solar array.

14. The system of claim 13, further comprising:
a sensor configured to supply data to said computer;
said computer configured to interpret said data; and
said computer further configured to automatically deploy or retract said solar array depending upon said data.

15. The system of claim 14, wherein said sensor is a sensor selected from the list comprising: a solar sensor; a motion sensor; and an audio sensor.

16. The system of claim 13, further comprising:
a remote weather detection system generating weather data;
said computer configured to receive said weather data; and
said computer further configured to automatically deploy or retract said solar array depending upon said weather data.

17. The system of claim 11, further comprising:
a wall separating said container interior space into at least two rooms; and
wherein access to at least one of said at least two rooms is restricted.

18. The system of claim 17, further comprising:
a first access door configured to provide access to a first of said at least two rooms;
a second access door configured to provide access to a second of said at least two rooms;
whereby access to said first access door is limited to a first party; and
whereby access to said second access door is limited to a second party.

19. A clamping connector for first and second tubular members comprising:
a bolt including a shaft and a head mounted on said shaft, said shaft including a distal end with lateral flats;
said bolt head including a proximate, cylindrical spacer and an anchor mounted on said spacer;
said anchor including ends projecting outwardly from said spacer and configured for capturing one of said members; and
a retaining nut threadably mounted on said shaft within said one member.

20. The clamping connector according to claim 19 wherein:
said bolt head anchor has a generally oblong configuration; and
said second tubular member includes an opening with an oblong configuration corresponding to said anchor configuration.
